(19) United States
(12) Patent Application Publication
(10) Pub. No.: US 2012/0225968 A1
(43) Pub. Date: Sep. 6, 2012

(54) INK COMPOSITION FOR INK JET

(75) Inventors: Tomohito Nakano, Shiojiri (JP); Toshiyuki Miyabayashi, Shiojiri (JP); Shinichi Kato, Matsumoto (JP); Hiroki Nakane, Matsumoto (JP); Hirotoshi Koyano, Kobe (JP); Yoshinobu Sato, Osaka (JP); Hiroshi Sawada, Ikaruga (JP); Kenji Kitada, Matsumoto (JP)

(73) Assignee: Seiko Epson Corporation, Tokyo (JP)

(21) Appl. No.: 13/337,581

(22) Filed: Dec. 27, 2011

(30) Foreign Application Priority Data
Dec. 27, 2010 (JP) 2010-290094
Nov. 21, 2011 (JP) 2011-253980

(51) Int. Cl. C09D 11/10

(52) U.S. Cl. 522/16; 522/96

(57) ABSTRACT

An ink composition for ink jet providing excellent in the curability based on ultraviolet irradiation in the presence of water or a solvent, the ejection stability with respect to the factors such as dot loss or flight deflection, and the storage stability of ink. Also provided herein is an ink composition for ink jet including: a pigment; a water-soluble organic solvent; a surfactant; at least either of a urethane (meth)acrylate being represented by the following general formula (1) and having a weight average molecular weight of 1,000 to 10,000 and a cross-linked urethane (meth)acrylate having a constitutional unit including the urethane (meth)acrylate; a compound having a radical polymerizable group(s); a photoradical polymerization initiator; and water:

A¹-O—(CONH—B¹—NHCOO—C¹—O)ₙ—CONH—B¹—NH—COO-D¹ (1)

where each of A¹, B¹, C¹, D¹, and n in formula (1) are described herein.

The entire disclosure of Japanese Patent Application No. 2010-290094, filed on Dec. 27, 2010, and No. 2011-253980, filed on Nov. 21, 2011, are expressly incorporated by reference herein.

### BACKGROUND OF THE INVENTION

1. Field of the Invention

The present invention relates to an ink composition for ink jet.

2. Description of the Related Art

The ink jet printing method is a method in which ink droplets are ejected from nozzles to be attached to the surface of a substrate such as the surface of a sheet of paper, then the solvent of the ink is dried from the attached ink so as for the colorants in the ink to be fixed to the surface of the substrate and thus printing is performed. According to this method, high-resolution and high-quality images can be printed at high speeds.

Aqueous inks used in ink jet printing contain no volatile components in the inks and hence are excellent from the viewpoints of safety and environmental concerns; however, when such aqueous inks are used for printing on high-quality paper or regular paper, the inks tend to spread on the paper, and when such inks are used for printing on paper used in running on, drying is insufficient and hence it is difficult to perform high-speed printing. Further, there is caused a problem that it is impossible to fix the ink printed on ink-nonabsorbing recording media such as polymer resin film, earthenware or a glass substrate. For the purpose of solving such problems, various aqueous ultraviolet curable inks have hitherto been disclosed.

For example, Japanese Patent No. 4411852 discloses an aqueous ultraviolet curable ink-jet ink having a particle size and a zeta potential respectively falling within predetermined ranges. It is also disclosed that this ink-jet ink contains 20% or more by mass of a light curable monomer or oligomer having three or more photofunctional groups, and an emulsion-polymerizable compound.

For example, Japanese Patent No. 3659658 discloses an ink for ink jet printer wherein the viscosity of the ink is reduced by emulsifying and dispersing a specific ultraviolet curable resin in water.

For example, International Publication No. 01/057145 discloses a photopolymerizable aqueous ink including a photopolymerizable resin and a photopolymerization initiator, wherein the photopolymerizable resin is composed of oligomer particles present in an emulsified condition, monomers present within the oligomer particles and the photopolymerization initiator.

For example, Japanese Patent Laid-Open No. 2010-229179 discloses an ink for ink jet that is a photopolymerizable aqueous ink including a photopolymerizable resin and a photopolymerization initiator, wherein the viscosity of the ink is regulated to be 10 mPa·s or more and 60 mPa·s or less by using a water-soluble organic solvent and a surfactant.

As described above, among inks based on conventional art, some inks use a surfactant for the purpose of emulsifying and dispersing a light curable resin in water, and some others include a monomer and a photopolymerization initiator made to be present in oligomer particles being in an emulsified condition.

However, conventional inks cause problems with respect to the curability based on ultraviolet irradiation in the presence of water or an organic solvent, with respect to the ejection stability involving the factors such as dot loss or flight deflection and with respect to the storage stability of ink.

### SUMMARY OF THE INVENTION

Accordingly, the present invention takes as its object the provision of an ink composition for ink jet, excellent in the curability based on ultraviolet irradiation in the presence of water or a solvent, the ejection stability involving the factors such as dot loss or flight deflection, and the storage stability of ink.

The present inventors made a diligent study for the purpose of solving the aforementioned problems. Consequently, the present inventors have perfected the present invention by discovering that the aforementioned problems can be solved by an ink composition for ink jet, including: a pigment; a water-soluble organic solvent; a surfactant; at least either of a urethane (meth)acrylate having a predetermined structure and a predetermined weight average molecular weight and a cross-linked derivative of the urethane (meth)acrylate; a compound having a radical polymerizable group(s); a photoradical polymerization initiator; and water.

Specifically, the present invention is as follows.

[1] An ink composition for ink jet including: a pigment; a water-soluble organic solvent; a surfactant; at least either of a urethane (meth)acrylate being represented by the following general formula (1) and having a weight average molecular weight of 1,000 to 10,000 and a cross-linked urethane (meth)acrylate having a constitutional unit including the urethane (meth)acrylate; a compound having a radical polymerizable group(s); a photoradical polymerization initiator; and water:

A¹-O—(CONH—B¹—NHCOO—C¹—O)ₙ—CONH—B¹—NH—COO-D¹ (1)

wherein in formula (1), n represents a natural number of 1 to 30, A¹ represents a residue of a hydroxyl group-containing (meth)acrylate, B¹ represents a residue of diisocyanate, C¹ represents a residue of a diol of an acyclic hydrocarbon or a cyclic hydrocarbon, and D¹ represents a residue of a polyoxyalkylene glycol monoalkyl ether.

[2] The ink composition for ink jet according to [1], wherein the urethane (meth)acrylate is obtained by allowing to react with each other the hydroxyl group-containing (meth)acrylate, the diisocyanate, the diol of the acyclic hydrocarbon or the cyclic hydrocarbon and the polyoxyalkylene glycol monoalkyl ether.

[3] The ink composition for ink jet according to [1], wherein the diisocyanate is one or more selected from the group consisting of isophorone diisocyanate, hexamethylene diisocyanate, hydrogenated xylylene diisocyanate and hydrogenated diphenylmethane diisocyanate.

[4] The ink composition for ink jet according to [1], wherein the number of carbon atoms in the diol of the acyclic hydrocarbon or the cyclic hydrocarbon is 6 to 20.

[5] The ink composition for ink jet according to [4], wherein the diol, having a number of carbon atoms of 6 to 20, of the acyclic hydrocarbon or the cyclic hydrocarbon is one or more selected from the group consisting of 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanediol, 1,20-eicosanediol, polypropylene glycol, aliphatic polycarbonate polyol, aliphatic polyester polyol, aliphatic polycaprolactone diol, hydrogenated bisphenol A, ethylene oxide-modified hydrogenated bisphenol A, propylene oxide-modified hydrogenated bisphenol A, 1,4-cyclohexanediol and tricyclodecanedimethanol.

[6] The ink composition for ink jet according to [1], wherein the hydroxyl group-containing (meth)acrylate is one or more selected from the group consisting of polypropylene glycol mono(meth)acrylate, pentaerythritol tri(meth)acrylate and dipentaerythritol penta(meth)acrylate.

[7] The ink composition for ink jet according to [1], wherein the polyoxyalkylene glycol monoalkyl ether is represented by the following general formula (2):

HO—(CH₂CH₂O)ₘ—R (2)

wherein in formula (2), R represents an alkyl group and m represents a natural number of 9 to 90.

[8] The ink composition for ink jet according to [1], wherein the cross-linked urethane (meth)acrylate is prepared by cross-linking with a bifunctional or higher functional cross-linking agent.

[9] The ink composition for ink jet according to [8], wherein the cross-linking agent is a mercapto group-containing compound.

[10] The ink composition for ink jet according to [1], wherein a light curable aqueous emulsion includes: at least either of the urethane (meth)acrylate and the cross-linked urethane (meth)acrylate; and the compound having a radical polymerizable group(s) and the photoradical polymerization initiator emulsified and dispersed with at least either of the urethane (meth)acrylate and the cross-linked urethane (meth)acrylate.

[11] The ink composition for ink jet according to [10], wherein the compound having a radical polymerizable group(s) is a compound having in the molecule thereof three or more (meth)acryloyl groups.

[12] The ink composition for ink jet according to [1], wherein the photoradical polymerization initiator is a hydrophobic photopolymerization initiator.

[13] The ink composition for ink jet according to [1], wherein the photoradical polymerization initiator includes two or more photoradical polymerization initiators including at least a thioxanthone-based photoradical polymerization initiator.

[14] The ink composition for ink jet according to [1], wherein the compound having a radical polymerizable group(s) includes a urethane (meth)acrylate for fixing.

[15] The ink composition for ink jet according to [1], further including a fluorescent brightening agent.

[16] The ink composition for ink jet according to [1], wherein the water-soluble organic solvent includes at least either of a polar solvent and a permeable solvent.

[17] The ink composition for ink jet according to [16], wherein the polar solvent is a heterocyclic compound.

### BRIEF DESCRIPTION OF THE DRAWINGS

The invention will be described with reference to the accompanying drawings, wherein like numbers reference like elements.

FIG. 1 is a schematic diagram macroscopically illustrating the light curable aqueous emulsion of the present invention; and

FIG. 2 is a schematic diagram microscopically illustrating the light curable aqueous emulsion of the present invention.

### DETAILED DESCRIPTION OF THE PREFERRED EMBODIMENTS

Hereinafter, the embodiments for implementing the present invention are described in detail. The present invention is not limited to the following embodiments and can be implemented in various modifications within the scope of the gist of the present invention.

In the present specification, the “curability” means a property such that curing occurs as a result of sensing light; the “adhesion” means a property such that the coating film (of ink) is hardly detached from the surface of the substrate; the “ejection stability” means a property such that ink droplets are always stably ejected from the nozzles without causing dot loss or flight deflection; the “storage stability” means a property such that the viscosity is hardly changed between before and after the storage; and the “dispersibility” means a property such that solid particles are dispersed in a liquid and a stable suspension is formed over a long period of time.

In the present invention, the “recorded matter” means a cured product formed on a recording medium by the ink recorded thereon. The cured product in the present specification means a cured substance including a cured film or a coating film.

Also, in the present specification, “(meth)acrylate” means at least either of an acrylate and a methacrylate corresponding to the acrylate, and “(meth)acryloyl” means at least either of an acryloyl and a methacryloyl corresponding to the acryloyl.

Ink Composition for Ink Jet

An embodiment of the present invention relates to an ink composition for ink jet (hereafter, also simply referred to as the “ink composition”). The ink composition includes: a pigment; a water-soluble organic solvent; a surfactant; at least either of a urethane (meth)acrylate being represented by the following general formula (1) and having a weight average molecular weight of 1,000 to 10,000 and a cross-linked urethane (meth)acrylate having a constitutional unit including the urethane (meth)acrylate; a compound having a radical polymerizable group(s); a photoradical polymerization initiator; and water:

A¹-O—(CONH—B¹—NHCOO—C¹—O)ₙ—CONH—B¹—NH—COO-D¹ (1)

wherein in formula (1), n represents a natural number of 1 to 30, A¹ represents a residue of a hydroxyl group-containing (meth)acrylate, B¹ represents a residue of diisocyanate, C¹ represents a residue of a diol of an acyclic hydrocarbon or a cyclic hydrocarbon, and D¹ represents a residue of a polyoxyalkylene glycol monoalkyl ether.

Hereinafter, the components included or possibly included in the ink composition for ink jet are described in detail.

Pigments

The ink composition of the present embodiment includes a pigment(s). As the pigment(s), those pigments that are usually used in aqueous pigment inks for ink jet can be used without imposing any particular restrictions.

Examples of the pigments usable as the aforementioned pigments include: organic pigments such as azo pigments (including, for example, azo lake pigments, insoluble azo pigments, condensed azo pigments and chelate azo pigments), polycyclic pigments (such as phthalocyanine pigments, perylene pigments, perinone pigments, anthraquinone pigments, quinaquridone pigments, dioxazine pigments, thioindigo pigments, isoindolinone pigments and quinophthalone pigments), nitro pigments, nitroso pigments and aniline black; inorganic pigments such as carbon black (such as furnace black, thermal lamp black, acetylene black and channel black), metal oxides, metal sulfides and metal chlorides; and extender pigments such as silica, calcium carbonate and talc.

Specific examples of the aforementioned pigments include: C.I. pigment yellow 64, 74, 93, 109, 110, 120, 128, 138, 139, 150, 151, 154, 155, 180, 185, 213; C.I. pigment red 122, 202, 209; C.I. pigment violet 19; C.I. pigment blue 15:3, 15:4, 60; C.I. pigment green 7(phthalocyanine green), 10(green gold), 36, 37; C.I. pigment brown 3, 5, 25, 26; and C.I. pigment orange 1, 2, 5, 7, 13, 14, 15, 16, 34, 36, 38, 64, 71.

The aforementioned pigments are preferably added to ink as pigment dispersions obtained by dispersing the pigments in water with the aid of dispersing agents, or alternatively, as pigment dispersions obtained by dispersing in water self-dispersing surface-treated pigments having hydrophilic groups introduced onto the surface of the pigments by taking advantage of chemical reaction or as pigment dispersions obtained by dispersing in water pigments coated with polymer.

The dispersing agents used in preparation of the former, namely, the pigment dispersions obtained by dispersing in water with the aid of dispersing agents are not particularly limited; however, examples of the usable dispersing agents include: polymer dispersing agents (proteins such as glue, gelatin, casein and albumin; natural rubbers such as gum arabic and gum tragacanth; glucosides such as saponin; fermentation products of alginic acid such as propylene glycol alginate, triethanolamine alginate and ammonium alginate; cellulose derivatives such as methyl cellulose, carboxymethyl cellulose and ethylhydroxy cellulose; polyvinyl alcohols; polypyrrolidones; acrylic resins such as polyacrylic acid, acrylic acid-acrylonitrile copolymer, potassium acrylate-acrylonitrile copolymer, vinyl acetate-acrylic acid ester copolymer and acrylic acid-acrylic acid ester copolymer; styrene-acrylic resins such as styrene-acrylic acid copolymer, styrene-methacrylic acid copolymer, styrene-methacrylic acid-acrylic acid ester copolymer and styrene-m-methylstyrene-acrylic acid copolymer; vinyl acetate-based copolymers such as styrene-maleic acid copolymer, styrene-maleic anhydride copolymer, vinylnaphthalene-acrylic acid copolymer, vinyl acetate-ethylene copolymer, vinyl acetate-fatty acid vinyl ethylene copolymer, vinyl acetate-maleic acid ester copolymer, vinyl acetate-croton copolymer and vinyl acetate-acrylic acid copolymer, and the salts of these), and surfactants (various anionic surfactants, nonionic surfactants and amphoteric surfactants).

On the other hand, of the latter pigments, the self-dispersing surface-treated pigments having hydrophilic groups introduced into the pigments are such that the pigments are made capable of being dispersed or dissolved in water without using any dispersing agent by the surface treatment in which carboxyl groups and the salts of such groups are directly bonded onto the surface of the pigments. Specifically, such pigments can be obtained by grafting functional groups or functional group-containing molecules to the surface of the pigments with the aid of a physical treatment such as vacuum plasma treatment or a chemical treatment using an oxidant such as sodium hypochlorite or ozone. A single type of functional group or a plurality of types of functional groups may be grafted to one pigment particle. The types of the grafted functional groups and the grafting extent may be appropriately determined in consideration of the factors such as the dispersion stability in the ink, the color concentrations and the dryness of the front face of the ink jet head.

Also, of the latter pigments, the aforementioned pigments coated with polymer are not particularly limited; however, for example, such pigments can be obtained in such a way that the pigments are dispersed with the aid of dispersing agents each having a polymerizable group(s), and then emulsion polymerization is performed in water by using a monomer (copolymerizable monomer) copolymerizable with the dispersing agent and a photoradical polymerization initiator. Among such polymers, preferably usable are the polymers obtained in such a way that a monomer or an oligomer having as double bonds at least any of an acryloyl group, a methacryloyl group, a vinyl group and an allyl group is polymerized by a heretofore known polymerization method. For the aforementioned emulsion polymerization, common methods can be used; the polymerization proceeds due to a free radical generated by thermolysis of the water-soluble photoradical polymerization initiator in the presence of an emulsifying agent.

The pigments and the dispersing agents constituting the aforementioned pigments dispersions may be used each alone or in combinations of two or more thereof.

Because there are obtained advantageous effects such that clear images are formed on various types of media, the pigment dispersions are each preferably included in an ink composition in a content of 0.05 to 25% by mass and more preferably 0.1 to 20% by mass in terms of solid content in relation to the total amount (100% by mass) of the ink composition.

Water-Soluble Organic Solvents

The ink composition of the present embodiment includes a water-soluble organic solvent. The inclusion of the water-soluble organic solvent in the ink composition enables to prevent the clogging in the vicinity of the nozzles of the ink jet head, to appropriately control the permeability of the ink into the recording medium or the spreading of the ink on the recording medium, and to provide the ink with drying property.

Because there are obtained advantageous effects such as the stable ejection stability free from dot loss, appropriate wetness and spreading on a wide range of media, the water-soluble organic solvent preferably includes at least either of a polar solvent and a permeable solvent.

The polar solvent is not particularly limited; however, examples of the polar solvent include 2-pyrrolidone, N-methylpyrrolidone, ε-caprolactam, dimethyl sulfoxide, sulfolane, morpholine, N-ethylmorpholine and 1,3-dimethyl-2-imidazolidine. The addition of the polar solvent provides an effect to improve the dispersibility of the capsulated pigment particles in the ink composition and enables to improve the ejection stability of the ink.

The polar solvent is preferably a heterocyclic compound; preferable among others are 2-pyrrolidone, N-methylpyrrolidone, pyrrole, furan, thiophene, imidazole, oxazole, thiazole, pyrazole, isoxazole, isothiazole, pyridine, pyridazine, pyrimidine, pyrazine, piperidine, piperazine, morpholine, 2H-pyran and 4H-pyran; 2-pyrrolidone is more preferable.

The permeable solvent is not particularly limited; examples of the permeable solvent include 1,2-alkanediol, acetylene glycol, alkylene glycol, alkylene glycol alkyl ether and glycol ether. In particular, as compared to the use of permeable solvents other than 1,2-alkanediol, the use of 1,2-alkanediol enables the more efficient reduction of the coalescence in the recorded matter when printing is made on a recording medium scarcely absorbing or not absorbing ink, such as paper used in running on or a plastic film. Among the 1,2-alkanediols, in particular, 1,2-hexanediol remarkably exhibits such an effect.

The water-soluble organic solvent preferably includes one or more selected from the group consisting of 2-pyrrolidone, glycol ether, 1,2-alkanediol, alkylene glycol and alkylene glycol alkyl ether.

1,2-Alkanediol is not particularly limited; however, specific example of 1,2-alkanediol include 1,2-octanediol, 1,2-hexanediol, 1,2-pentanediol and 4-methyl-1,2-pentanediol.

Alkylene glycol is not particularly limited; however, specific examples of alkylene glycol include ethylene glycol, diethylene glycol, triethylene glycol, tetraethylene glycol, propylene glycol and dipropylene glycol monomethyl ether.

Alkylene glycol alkyl ether which is liquid under ordinary temperature and pressure is not particularly limited; however, examples of alkylene glycol alkyl ether include the ethylene glycol based ethers and the propylene glycol based ethers containing as the basic components the aliphatic groups such as methyl, n-propyl, i-propyl, n-butyl, i-butyl, hexyl and 2-ethylhexyl and the double bond-containing groups such as allyl and phenyl. These compounds are colorless and low in odor and each have an ether group and a hydroxyl group in the molecule thereof, and hence are each a component liquid at ordinary temperature provided with the properties of both of an alcohol and an ether. Alkylene glycol alkyl ether includes a monoalkyl ether type in which one hydroxyl group is substituted and a dialkyl ether type in which both hydroxyl groups are substituted; these alkylene glycol alkyl ethers can be used in combinations of a plurality thereof.

The aforementioned alkylene glycol alkyl ether is not particularly limited; however, specific examples of alkylene glycol alkyl ether include: alkylene glycol monoalkyl ethers such as ethylene glycol monomethyl ether, ethylene glycol monoethyl ether, ethylene glycol monoisopropyl ether, ethylene glycol monobutyl ether, ethylene glycol monomhexyl ether, ethylene glycol monophenyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether (TEGmBE), tetraethylene glycol monomethyl ether, tetraethylene glycol monoethyl ether, tetraethylene glycol monobutyl ether, propylene glycol monomethyl ether, propylene glycol monoethyl ether, dipropylene glycol monomethyl ether and dipropylene glycol monoethyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether and polyethylene glycol dimethyl ether.

Alkylene glycol monoalkyl ether acetate, a derivative of the aforementioned alkylene glycol monoalkyl ether, is also usable. The alkylene glycol monoalkyl ether acetate is not particularly limited; however, examples of the alkylene glycol monoalkyl ether acetate include ethylene glycol monoethyl ether acetate, diethylene glycol monoethyl ether acetate, propylene glycol monoethyl ether acetate and dipropylene glycol monoethyl ether acetate.

The water-soluble organic solvents may be used each alone or in combinations of two or more thereof.

For the purpose of ensuring appropriate physical property values (such as viscosity) of ink, appropriate printing quality and reliability, the water-soluble solvent is included preferably in a content of 1 to 40% by mass and more preferably in a content of 2 to 30% by mass in relation to the total amount (100% by mass) of the ink composition.

Surfactants

The ink composition of the present embodiment includes a surfactant. The surfactant is not particularly limited; however, for example, silicone-based surfactants such as polyester-modified silicone and polyether-modified silicone can be used; polyether-modified polydimethylsiloxane or polyester-modified polydimethylsiloxane are particularly preferably used. Specific examples of the silicone-based surfactant include: BYK-331, BYK-333, BYK-375, BYK-347, BYK-348, BYK-349, BYK-UV3500, 3510, 3530, 3570 (all these manufactured by Byk-Chemie Japan Co., Ltd.).

The surfactants may be used each alone or in combinations of two or more thereof.

Because there is obtained an advantageous effect of dot spreading on the media, the surfactant is included preferably in a content of 0.01 to 3% by mass and more preferably 0.02 to 2% by mass in relation to the total amount (100% by mass) of the ink composition.

Urethane (Meth)Acrylate

The ink composition of the present embodiment can include a urethane (meth)acrylate having a predetermined structure and a predetermined weight average molecular weight. Such a urethane (meth)acrylate has a feature of being excellent in self-emulsifying capability and emulsifiability.

Constitution of Urethane (Meth)Acrylate

The urethane (meth)acrylate has a weight average molecular weight of 1,000 to 10,000 and a structure represented by the following general formula (1):

A¹-O—(CONH—B¹—NHCOO—C¹—O)ₙ—CONH—B¹—NH—COO-D¹ (1)

wherein in formula (1), n represents a natural number of 1 to 30, A¹ represents a residue of a hydroxyl group-containing (meth)acrylate, B¹ represents a residue of diisocyanate, C¹ represents a residue of a diol of an acyclic hydrocarbon or a cyclic hydrocarbon, and D¹ represents a residue of a polyoxyalkylene glycol monoalkyl ether.

The residue as referred to herein means, in the structure of the starting material of the urethane (meth)acrylate represented by the foregoing general formula (1), the moiety not including the functional group forming the urethane bond; specifically, the residue means the moiety (represented by A¹) not including the hydroxyl group in the case of the hydroxyl group-containing (meth)acrylate, the moiety (B¹) not including the isocyanate group in the case of diisocyanate, the moiety (C¹) not including the hydroxyl group in the case of the diol of an acyclic hydrocarbon or a cyclic hydrocarbon and the moiety (D¹) not including the hydroxyl group in the case of the polyoxyalkylene glycol monoalkyl ether.

The weight average molecular weight of the urethane (meth)acrylate represented by the foregoing general formula (1) can be derived by measuring the molecular weight distribution on the basis of gel permeation chromatography (GPC). The weight average molecular weight as referred to in the present specification means the weight average molecular weight determined relative to polystyrene standards, and is measured with a GPC(HLC-8220(trade name), manufactured by Tosoh Corporation) in which serially-connected three columns TSK-gel Super HZM-M (exclusion limit molecular weight: 4×10⁶, molecular weight fraction range: 266 to 4×10⁶, number of theoretical stages: 16,000 stages/column, packing material: styrene-based copolymer, packing particle size: 3 μm) are used.

The weight average molecular weight of the urethane (meth)acrylate represented by the foregoing general formula (1) is 1,000 to 10,000 and preferably 2,000 to 8,000. When the weight average molecular weight falls within the aforementioned range, the urethane (meth)acrylate tends to form micelles, is excellent in self-emulsifiability, and further there is obtained an advantageous effect such that hydrophobic substances tend to be included within the micelles. This is probably because the adoption of the urethane (meth)acrylate represented by the foregoing general formula (1) provides a satisfactory balance between hydrophilicity and hydrophobicity.

In the foregoing general formula (1), n represents a natural number of 1 to 30. The specific numerical value of n is determined by regulating the aforementioned weight average molecular weight.

Hydroxyl Group-Containing (Meth)Acrylate

The hydroxyl group-containing (meth)acrylate is a compound which gives the structure of A¹ in the foregoing general formula (1). The hydroxyl group-containing (meth)acrylate is used for the purpose of introducing a polymerizable group(s) into the foregoing general formula (1). Specifically, the hydroxyl group-containing (meth)acrylate is a compound having one or more (meth)acryloyl groups and one hydroxyl group, and the urethanation reaction of the hydroxyl group with one isocyanate group in the diisocyanate introduces a (meth)acryloyl group(s) to one terminal of the main chain of the urethane (meth)acrylate. The introduction of at least one (meth)acryloyl group enables photopolymerization (photocuring), and the introduction of two or more (meth)acryloyl groups increases the photopolymerization rate and provides an advantageous effect to increase the hardness of the cured product.

The monofunctional monohydroxymono(meth)acrylate is not particularly limited; however, examples of the monohydroxymono(meth)acrylate include: 2-hydroxyethyl (meth)acrylate, 2-hydroxypropyl (meth)acrylate, polyethylene glycol mono(meth)acrylate, polypropylene glycol mono(meth)acrylate and polycaprolactone mono(meth)acrylate.

The bifunctional monohydroxydi(meth)acrylate is not particularly limited; however, examples of the monohydroxydi(meth)acrylate include glycerol di(meth)acrylate.

The trifunctional or higher functional monohydroxypoly(meth)acrylate is not particularly limited; however, examples of the monohydroxypoly(meth)acrylate include pentaerythritol tri(meth)acrylate and dipentaerythritol penta(meth)acrylate.

Because an emulsion having a low viscosity is obtained, preferable among these is polypropylene glycol mono(meth)acrylate and more preferable among these is polypropylene glycol monoacrylate. On the other hand, particularly because an emulsion excellent in curability is obtained, preferable as the hydroxyl group-containing (meth)acrylate is at least either of pentaerythritol tri(meth)acrylate and dipentaerythritol penta(meth)acrylate.

The aforementioned hydroxyl group-containing (meth)acrylates may be used each alone or in combinations of two or more thereof.

Diisocyanate

The diisocyanate is a compound which gives the structure of B¹ in the foregoing general formula (1). The diisocyanate means an organic diisocyanate having two reactive isocyanate groups in one molecule thereof.

A urethane (meth)acrylates synthesized by using an organic polyisocyanate having three or more isocyanate groups in the molecule thereof tends to be high in molecular weight and tends to be high in viscosity. The emulsion (aqueous emulsion) prepared by emulsifying in water such a urethane (meth)acrylate having the following structure also tends to be high in viscosity: the concerned structure has a hydrophilic group in the molecule of the urethane (meth)acrylate, wherein the main chain is formed of a polyisocyanate having three or more isocyanate groups, and the branched chains are formed of a molecular chain having at least one hydrophilic group and a molecular chain having at least two or more (meth)acryloyl groups.

On the contrary, the urethane (meth)acrylate synthesized by using a diisocyanate having two isocyanate groups in the molecule thereof has a linear structure in which: the structure derived from the diisocyanate and the structure derived from the diol are linearly arranged; and as shown in the foregoing general formula (1), there is at one terminal a hydrophilic group derived from polyoxyalkylene glycol monoalkyl ether, and there is arranged at the other terminal a hydrophobic moiety in which to a structure derived from a (meth)acrylate having one or more (meth)acryloyl group and one hydroxyl group, a structure derived from the diol of an acyclic hydrocarbon or a cyclic hydrocarbon having two hydroxyl groups in the molecule thereof is bonded through diisocyanate by urethane bond. Because of such a structure as described above, the urethane (meth)acrylate synthesized by using a diisocyanate having two isocyanate groups in the molecule thereof is particularly excellent in emulsifiability in water and can drastically reduce the viscosity of the emulsion (aqueous emulsion) as compared to the emulsions of the aforementioned conventional urethane (meth)acrylates.

The diisocyanate is not particularly limited; however, examples of the diisocyanate include: diisocyanates having an alicyclic hydrocarbon skeleton such as isophorone diisocyanate; diisocyanates having an aliphatic hydrocarbon skeleton such as hexamethylene diisocyanate; diisocyanates having an aromatic hydrocarbon skeleton such as xylylene diisocyanate, tolylene diisocyanate and diphenylmethane diisocyanate; and diisocyanates having a hydrogenated aromatic hydrocarbon skeleton such as hydrogenated xylylene diisocyanate and hydrogenated diphenylmethane diisocyanate.

Because there is obtained an advantageous effect such that the cured product of the urethane (meth)acrylate hardly undergoes yellowing due to sun light (ultraviolet light), preferable among these diisocyanates are one or more selected from the group consisting of isophorone diisocyanate, hexamethylene diisocyanate, hydrogenated xylylene diisocyanate and hydrogenated diphenylmethane diisocyanate.

The aforementioned diisocyanates may be used intramolecularly or intermolecularly each alone or in combinations of two or more thereof.

Diol of Acyclic Hydrocarbon or Cyclic Hydrocarbon

The diol of an acyclic hydrocarbon or a cyclic hydrocarbon is a compound which gives the structure of C¹ in the foregoing general formula (1). The diol is introduced for the purpose of regulating the degree of the hydrophobicity of the hydrophobic moiety of the urethane (meth)acrylate represented by the foregoing general formula (1). The diol is selected so as to provide a satisfactory hydrophobicity. As specific examples, one or more diols selected from the group consisting of aliphatic, alicyclic and aromatic diols each having two hydroxyl groups in one molecule thereof are preferably used; more preferable among such diols are diols exhibiting satisfactory hydrophobicity. Specifically, because of being particularly excellent in the concerned hydrophobicity, the number of the carbon atoms in the diol of the acyclic hydrocarbon or the cyclic hydrocarbon is preferably 6 to 20.

It is also possible to select as the diols, according to the intended use or intended purpose, those diols which are appropriate for controlling the rigidity or flexibility of the urethane (meth)acrylate and exhibit satisfactory hydrophobicity.

As the aforementioned aliphatic diols, heretofore known aliphatic diols can be used without imposing any particular restrictions as long as the aliphatic diols do not have in the molecule thereof any aromatic structure or any alicyclic structure. Specific examples of the aliphatic diol include: 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanediol, 1,20-eicosanediol, polypropylene glycol (such as dipropylene glycol and tripropylene glycol), aliphatic polycarbonate polyol, aliphatic polyester polyol and aliphatic polycaprolactone diol.

As the aforementioned aromatic diols, heretofore known aromatic diols can be used without imposing any particular restrictions as long as the aromatic diols have in the molecule thereof an aromatic structure. Specific examples of the aromatic diol include: biphenyl-4,4′-diol, 1,4-benzenediol, bisphenol A, ethylene oxide-modified bisphenol A, propylene oxide-modified bisphenol A, aromatic polycarbonate polyol and aromatic polyester polyol.

As the aforementioned alicyclic diols, heretofore known alicyclic diols can be used without imposing any particular restrictions as long as the alicyclic diols have in the molecule thereof an alicyclic structure. Specific examples of the alicyclic diol include: hydrogenated bisphenol A, ethylene oxide-modified hydrogenated bisphenol A, propylene oxide-modified hydrogenated bisphenol A, 1,4-cyclohexanediol, tricyclodecanedimethanol, alicyclic polycarbonate polyol and alicyclic polyester polyol.

Because satisfactory emulsification in water is achieved and the cured product of the urethane (meth)acrylate hardly undergoes yellowing due to sun light (ultraviolet light), preferable among these are aliphatic diols and alicyclic diols. Preferable among the aliphatic diols are one or more selected from the group consisting of 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanediol, 1,20-eicosanediol, polypropylene glycol, aliphatic polycarbonate polyol, aliphatic polyester polyol and aliphatic polycaprolactone diol. Preferable among the alicyclic diols are one or more selected from the group consisting of hydrogenated bisphenol A, ethylene oxide-modified hydrogenated bisphenol A, propylene oxide-modified hydrogenated bisphenol A, 1,4-cyclohexanediol and tricyclodecanedimethanol.

The aforementioned diols may be used intramolecularly or intermolecularly each alone or in combinations of two or more thereof.

Polyoxyalkylene Glycol Monoalkyl Ether

The polyoxyalkylene glycol monoalkyl ether is a compound which gives the structure of D¹ in the foregoing general formula (1). Polyoxyalkylene glycol monoalkyl ether is a compound in which one hydroxyl group of polyoxyalkylene glycol is blocked with an alkyl group, and is represented by the following general formula (2):

HO—(CH₂CH₂O)ₘ—R (2)

wherein in formula (2), R represents an alkyl group and m represents a natural number of 9 to 90.

The urethanation reaction of the hydroxyl group with one isocyanate group in the diisocyanate introduces the hydroxyl group to one terminal of the main chain of the urethane (meth)acrylate. Consequently, the urethane (meth)acrylate has a structure of an amphiphilic substance which has a hydrophilic moiety at one terminal of the linear main chain of the substance, and has a hydrophobic moiety constituted of one or more polymerizable (meth)acryloyl groups and hydrophobic groups at the other terminal of the linear main chain; thus, the urethane (meth)acrylate becomes particularly excellent in emulsifiability in water.

Because there is obtained an advantageous effect such that the hydrophilicity can be optionally regulated, the polyoxyalkylene glycol monoalkyl ether preferably includes in the molecule thereof a polyoxyethylene structure.

The polyoxyethylene structure is the repeated structure of the oxyethylene group. The average repetition number of the oxyethylene groups, namely, m in the foregoing general formula (2) is determined by regulating the balance between hydrophilicity and hydrophobicity so as to result in satisfactory emulsification in water of the urethane (meth)acrylate, and is preferably a natural number of 9 to 90, more preferably a natural number of 9 to 60 and furthermore preferably a natural number of 9 to 30.

The polyoxyalkylene glycol monoalkyl ether is not particularly limited; however, examples of the polyoxyalkylene glycol monoalkyl ether include polyethylene glycol monoalkyl ethers such as polyethylene glycol monomethoxy ether and polyethylene glycol monoethoxy ether.

It is also possible to use polyoxyalkylene glycol monoalkyl ethers including in the molecules thereof, in addition to the polyoxyethylene structure, other polyoxyalkylene structures. In this case, it is preferable for emulsification that the polyoxyethylene structure be located on the side of the terminal alkyl group. Examples of the polyoxyalkylene structure usable in this case together with the polyoxyethylene structure include the polyoxypropylene structure and the polyoxytetramethylene structure. The repetition number of the oxyalkylene group of the polyoxyalkylene structure used together with the polyoxyethylene structure is appropriately determined in consideration of the balance between hydrophilicity and hydrophobicity of the concerned urethane (meth)acrylate.

The terminal alkyl group of the polyoxyalkylene glycol monoalkyl ether, namely, R in the foregoing general formula (2) is preferably a methyl group, an ethyl group or a propyl group, and more preferably a methyl group because the smaller is the number of carbon atoms of the alkyl group, the more the hydrophobicity is lowered and the more excellent is the emulsifiability.

The aforementioned polyoxyalkylene glycol monoalkyl ethers may be used each alone or in combinations of two or more thereof.

The urethane (meth)acrylates may also be used each alone or in combinations of two or more thereof.

The content of the urethane (meth)acrylate is preferably 5 to 50% by mass and more preferably 10 to 40% by mass in relation to the total amount (100% by mass) of the ink composition, for the purpose of enabling to form coating film and for the purpose of obtaining coating film performances such as satisfactory film strength and satisfactory adhesion, when used as the ink composition.

Cross-Linked Urethane (Meth)Acrylate

The ink composition of the present embodiment can include, together with or in place of the aforementioned urethane (meth)acrylate, a cross-linked urethane (meth)acrylate having a constitutional unit including the concerned urethane (meth)acrylate. The cross-linked urethane (meth)acrylate having as the constitutional unit the urethane (meth)acrylate represented by the general formula (1) is excellent in curability and more excellent in the storage stability of the emulsion.

Cross-Linking Agent

The aforementioned cross-linked urethane (meth)acrylate can be obtained by allowing the aforementioned urethane (meth)acrylate and a bifunctional or higher functional cross-linking agent to react with each other.

The use of a cross-linking agent enables to increase the molecular weight of the urethane (meth)acrylate. Thus, it is possible to obtain a cross-linked urethane (meth)acrylate more excellent in curability and more excellent in the storage stability of the emulsion.

Gelification can be prevented by performing the reaction, neither in a solvent system nor in a solvent-free system, but in the oil system (oil phase) in an O/W emulsion.

The aforementioned bifunctional or higher functional crosslinking agent is preferably hydrophobic because this cross-linking agent reacts with the (meth)acryloyl group. In other words, the aforementioned bifunctional or higher functional crosslinking agent undergoes the Michael addition, in the oil phase of an emulsion, to the (meth)acryloyl group in the urethane (meth)acrylate represented by the general formula (1), and thus cross-links the concerned urethane (meth)acrylate.

Examples of such a cross-linking agent reacting with the (meth)acryloyl group include cross-linking agents having thiol groups or amino groups in the molecules thereof. Among such cross-linking agents, either of a multifunctional thiol compound and a multifunctional amine compound is preferable because of the capability of allowing the reaction to proceed rapidly, a multifunctional thiol compound being more preferable.

The aforementioned bifunctional and higher functional crosslinking agent is not particularly limited; however, examples of such a crosslinking agent include mercapto group-containing compounds and amino group-containing compounds. Preferable among these compounds are mercapto group-containing compounds because of being low in solubility in water and tending to be incorporated into the oil phase when dispersed in water.

The aforementioned mercapto group-containing compound is not particularly limited; however, examples of the mercapto group-containing compound include pentaerythritol tetrakis(3-mercaptopropionate) (hereinafter, also referred to as “PEMP”), trimethylolpropane tris(3-mercaptopropionate), tris-[(3-mercaptopropionyloxy)-ethyl]-isocyanurate, tetraethylene glycol bis(3-mercaptopropionate), dipentaerythritol hexakis(3-mercaptopropionate), pentaerythritol tetrakis(3-mercaptobutyrate) and trimethylolpropane tris(3-mercaptobutyrate).

The content of the aforementioned bifunctional or higher functional cross-linking agent is preferably 3 to 10% by mass and more preferably 5 to 8% by mass in relation to the total mass (100% by mass) of the (meth)acryloyl group-containing resin.

The “(meth)acryloyl group-containing resin” as referred to in the present specification means all the resins that contain the (meth)acryloyl groups undergoing cross-linking due to the aforementioned crosslinking agents. Accordingly, the concerned (meth)acryloyl group-containing resin includes the urethane (meth)acrylate represented by the foregoing general formula (1) and the below-described compound having three or more (meth)acryloyl groups in the molecule thereof.

Production Method of Urethane (Meth)Acrylate

Hereinafter, the production method of the aforementioned urethane (meth)acrylate is described. The urethane (meth)acrylate is obtained by allowing the aforementioned hydroxyl group-containing (meth)acrylate, diisocyanate, diol of an acyclic hydrocarbon or a cyclic hydrocarbon, and polyoxyalkylene glycol monoalkyl ether to react with each other. More specifically, the production method of the urethane (meth)acrylate includes a first step, a second step and a third step.

In the first step, a first urethane bond-containing reaction product represented by the following general formula (1a) by allowing the diisocyanate and the diol of an acyclic hydrocarbon or a cyclic hydrocarbon preferably having 6 to 20 carbon atoms to react with each other:

OCN—(B¹—NHCOO—C¹—O)ₙ—CONH—B¹—NCO (1a)

In the first step, the molar ratio between the diisocyanate and the diol of an acyclic hydrocarbon or a cyclic hydrocarbon having 6 to 20 carbon atoms is preferably 5:1 to 5:4 and more preferably 5:2 to 5:3.

In the second step, a second reaction product represented by the following general formula (1b) is obtained by allowing the first reaction product and the polyoxyalkylene glycol monoalkyl ether to react with each other:

OCN—(B¹—NHCOO—C¹—O)ₙ—CONH—B¹—NH—COO-D¹ (1b)

In the second step, the molar ratio between the first reaction product and the polyoxyalkylene glycol monoalkyl ether is preferably 1:0.5 to 1:1 because of resulting in satisfactory emulsification in water.

In the third step, the second reaction product and the hydroxyl group-containing (meth)acrylate are allowed to react to each other. In the third step, the molar ratio between the second reaction product and the hydroxyl group-containing (meth)acrylate is preferably 1:1.5 to 1:1 and more preferably 1:1.4 to 1:1.2.

Production Method of Cross-Linked Urethane (Meth)Acrylate

The production method of a cross-linked urethane (meth)acrylate is a production method of the aforementioned cross-linked urethane (meth)acrylate. The concerned production method includes a fourth step in which the urethane (meth)acrylate represented by the general formula (1), obtained by performing the first step to the third step and the aforementioned bifunctional or higher functional cross-linking agent are allowed to react with each other, so that the concerned urethane (meth)acrylate is cross-linked.

In the fourth step, in addition to the urethane (meth)acrylate represented by the foregoing general formula (1), the aforementioned compound having in the molecule thereof three or more (meth)acryloyl groups may also be allowed to react with the bifunctional or higher functional cross-linking agent.

In the fourth step, a urethane (meth)acrylate for fixing may further be added. In particular, when the substrate is made of polyvinyl chloride (hereinafter, also referred to as “PVC”), it is preferable to further add a urethane (meth)acrylate for fixing. Specifically, when a PVC substrate is used, the coating film (to be described below) is required to have adhesiveness to the PVC substrate. In this connection, the addition of the urethane (meth)acrylate for fixing makes satisfactory the adhesiveness to the substrate, and hence it can be said that the use of the urethane (meth)acrylate for fixing is preferable.

When a substrate made of a material other than PVC, for example, polyethylene terephthalate (PET) is used, the curability is made more satisfactory and the storage stability of the emulsion is more excellent because of the reason that the particles are fined, and hence the content (addition amount) of the urethane (meth)acrylate for fixing is preferably low, and the content of the compound having three or more (meth)acryloyl groups is preferably set at a correspondingly larger value.

In the fourth step, the ratio between the content of the urethane (meth)acrylate represented by the foregoing general formula (1) and (when present) the compound having in the molecule thereof three or more (meth)acryloyl groups and the content of the bifunctional or higher functional cross-linking agent is preferably 100:1 to 100:10 and more preferably 100:5 to 100:8 in terms of mass. When the content ratio is equal to or more than the lower limit of the aforementioned range, the curability and the storage stability come to be more excellent. When the content ratio is equal to or less than the upper limit of the aforementioned range, the occurrence of undissolved substances can be prevented, and the vanishing of the (meth)acryloyl group in the system is prevented and thus the curability can be maintained more satisfactory.

As described above, in the fourth step, the urethane (meth)acrylate represented by the foregoing general formula (1), the bifunctional or higher functional cross-linking agent such as a multifunctional thiol monomer, and one or more, as the optional components, selected from the group consisting of the compound having in the molecule thereof three or more (meth)acryloyl groups, the urethane (meth)acrylate for fixing, the photoradical polymerization initiator preferably included thioxanthone-based initiators and the fluorescent brightening agent are mixed together, and the resulting mixture is emulsified (dispersed in water) by dropwise adding water to the mixture. The obtained emulsion is heated, for example, at 80° C. for 6 hours, and consequently the Michael addition reaction is accelerated to yield the cross-linked urethane (meth)acrylate.

In this case, the compound having a (meth)acryloyl group and the cross-linking agent react with each other and consequently the compound having a (meth)acryloyl group is cross-linked. In other words, the cross-linking agent reacts not only with the urethane (meth)acrylate but with the compound having a (meth)acryloyl group. Accordingly, in the structure of the cross-linked urethane (meth)acrylate, there can be concomitantly present various cross-linked compounds such as a compound resulting from the mutual cross-linking of the urethane (meth)acrylates represented by the general formula (1), a compound resulting from the cross-linking between the urethane (meth)acrylate represented by the general formula (1) and the (meth)acryloyl group-containing compound, which is an included substance, and a compound resulting from the mutual crosslinking of the (meth)acryloyl group-containing compounds, which are included substances. The included substance as referred to herein means a substance present in the interior of a micelle when an emulsion is formed and a micelle structure is obtained.

As described above, when the compound having a (meth)acryloyl group and the cross-linking agent are allowed to react with each other, there occur a case where the whole of the compound having a (meth)acryloyl group is cross-linked and a case where part of the compound having a (meth)acryloyl group is cross-linked and the rest of the compound having a (meth)acryloyl group remains uncross-linked. A catalyst may also be used for the purpose of further accelerating the aforementioned Michael addition reaction.

Compound Having Radical Polymerizable Group(s)

The ink composition of the present embodiment includes a compound having a radical polymerizable group(s). The compound having a radical polymerizable group(s) undergoes a reaction in a chain-like manner, under the attack of the below-described initiator radical generated by the irradiation of light having a specific wavelength (a specific wavelength range). At the same time, the acryloyl group(s) of the urethane (meth)acrylate present in the same uniform field as the field in which the radical polymerizable compound is present also undergoes a reaction in a chain-like manner. In this way, the ink composition forms a cured film on the recording medium.

Examples of the radical polymerizable group(s) in the compound having a radical polymerizable group(s) include a (meth)acryloyl group, a vinyl group, a vinyl ether group and a mercapto group.

As the compound having a radical polymerizable group(s), included in the ink composition, a compound having in the structure thereof one or more (meth)acryloyl groups is particularly preferable, and a compound having in the structure thereof one or more acryloyl groups is more preferable. The compound having one or more radical polymerizable groups includes a monomer having a molecular weight of about a few hundreds, oligomers ranging from a dimer to a lower polymer consisting of several monomer units, having a molecular weight of approximately several thousands or less, and polymers having a molecular weight of several tens of thousands or less.

The compound having a radical polymerizable group(s) that has in the molecule thereof one (meth)acryloyl group is not particularly limited; however, examples of such a compound include: isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, butoxyethyl (meth)acrylate, ethoxy diethylene glycol (meth)acrylate, methoxy diethylene glycol (meth)acrylate, methoxy polyethylene glycol (meth)acrylate, methoxy propylene glycol (meth)acrylate, phenoxyethyl (meth)acrylate, tetrahydrofurfuryl (meth)acrylate, 2-hydroxyethyl (meth)acrylate, 2-hydroxypropyl (meth)acrylate, 2-hydroxy-3-phenoxypropyl (meth)acrylate, lactone-modified flexible (meth)acrylate, t-butylcyclohexyl (meth)acrylate, dicyclopentenyl (meth)acrylate, dicyclopentenyloxyethyl (meth)acrylate, glycidyl and isobornyl (meth)acrylate.

The compound having a radical polymerizable group(s) that has in the molecule thereof two (meth)acryloyl groups is not particularly limited; however, examples of such a compound include: triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A EO (ethylene oxide) adduct di(meth)acrylate, bisphenol A PO (propylene oxide) adduct di(meth)acrylate, neopentyl hydroxypivalate glycol di(meth)acrylate and polytetramethylene glycol di(meth)acrylate.

Among these, compounds having in the molecule thereof three or more (meth)acryloyl groups are more preferable as the compound having a radical polymerizable group(s) because such compounds are excellent in photopolymerizability.

The compound having a radical polymerizable group(s) that has in the molecule thereof three or more (meth)acryloyl groups is not particularly limited; however, examples of such a compound include: trimethylolpropane tri(meth)acrylate, ethylene oxide-modified trimethylolpropane tri(meth)acrylate, propylene oxide-modified trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, ditrimethylolpropane tetra(meth)acrylate, glycerol tri(meth)acrylate, glycerin ethoxy tri(meth)acrylate, glycerin propoxy tri(meth)acrylate, caprolactone-modified trimethylolpropane tri(meth)acrylate, pentaerythritol ethoxy tetra(meth)acrylate, epichlorohydrin-modified trimethylolpropane tri(meth)acrylate, tripentaerythritol octa(meth)acrylate, tetrapentaerythritol deca(meth)acrylate, polypentaerythritol poly(meth)acrylate and caprolactone-modified dipentaerythritol hexa(meth)acrylate.

The aforementioned compound having in the molecule thereof three or more (meth)acryloyl groups is not particularly limited; however, examples of such a compound include: oligomers having a molecular weight of approximately several thousands or less and having three or more (meth)acryloyl groups such as polyester (meth)acrylate, polyurethane (meth)acrylate (with the proviso that the aforementioned urethane (meth)acrylate is excluded), epoxy (meth)acrylate, polyether (meth)acrylate, oligo(meth)acrylate, alkyd (meth)acrylate and polyol (meth)acrylate; oligomers having in the molecule thereof three or more acryloyl groups and having a molecular weight of approximately several thousands or less; and polymer and dendrimer type (meth)acrylates having a molecular weight of approximately several ten thousands or less.

The aforementioned compounds having a radical polymerizable group(s) may be used each alone or in combinations of two or more thereof.

Because the compound having a radical polymerizable group(s) imparts excellent photopolymerizability (curability) to the ink composition, the compound having a radical polymerizable group(s) is included preferably in a content of 1 to 60% by mass and more preferably 5 to 50% by mass in relation to the total amount (100% by mass) of the ink composition.

Urethane (Meth)Acrylate for Fixing

The aforementioned compound having a radical polymerizable group(s) preferably includes a urethane (meth)acrylate for fixing. Thus, when a coating film including an emulsion is formed on a PVC substrate, the fixability (adhesiveness) of the coating film is made more excellent. As described above, because the compound having a radical polymerizable group(s) preferably includes a compound excellent in photopolymerizability (curability), it is preferable to use a urethane (meth)acrylate for fixing, making the adhesiveness more satisfactory, in combination with the concerned compound.

It is to be noted that the concerned urethane (meth)acrylate for fixing is different from the urethane (meth)acrylate represented by the foregoing general formula (1).

As described below, the urethane (meth)acrylate for fixing is constituted of a diisocyanate, a diol component having an aromatic skeleton and a hydroxyl group-containing (meth)acrylate.

The weight average molecular weight of the urethane (meth)acrylate for fixing is particularly preferably 1,000 to 10,000 and more preferably 3,000 to 8,000. When the weight average molecular weight falls within the aforementioned range, the urethane (meth)acrylate for fixing is excellent in the adhesiveness of the coating film to the PVC substrate and satisfactory with respect to the stability of the emulsion.

Hydroxyl Group-Containing (Meth)Acrylate

The hydroxyl group-containing (meth)acrylate is used for the purpose of introducing polymerizable groups. Specifically, the hydroxyl group-containing (meth)acrylate used in the present embodiment has one or more (meth)acryloyl groups and one hydroxyl group, and the urethanation reaction of the hydroxyl group-containing (meth)acrylate with an isocyanate group introduces one or more (meth)acryloyl groups to each of the both terminals of the main chain of the urethane (meth)acrylate for fixing. The introduction of at least one (meth)acryloyl group enables curing (photopolymerization), and the introduction of two or more (meth)acryloyl groups enables the increase of the curing rate and enables the increase of the hardness of the cured product.

Monohydroxy mono(meth)acrylate is not particularly limited; however, examples of monohydroxy mono(meth)acrylate include: 2-hydroxyethyl (meth)acrylate, 2-hydroxypropyl (meth)acrylate, polyethylene glycol mono(meth)acrylate, polypropylene glycol mono(meth)acrylate, polycaprolactone mono(meth)acrylate, glycerol di(meth)acrylate, pentaerythritol tri(meth)acrylate and dipentaerythritol penta(meth)acrylate.

The aforementioned hydroxyl group-containing (meth)acrylate may be used each alone or in combinations of two or more thereof.

Diisocyanate

The diisocyanate is not particularly limited; however, examples of the diisocyanate include: diisocyanates having a alicyclic hydrocarbon skeleton such as isophorone diisocyanate; diisocyanates having an aliphatic hydrocarbon skeleton such as hexamethylene diisocyanate; diisocyanates having an aromatic hydrocarbon skeleton such as xylylene diisocyanate, tolylene diisocyanate and diphenylmethane diisocyanate; and diisocyanates having a hydrogenated aromatic hydrocarbon skeleton such as hydrogenated xylylene diisocyanate and hydrogenated diphenylmethane diisocyanate.

Because the cured product of the urethane (meth)acrylate for fixing hardly undergoes yellowing due to sun light (ultraviolet light), preferable among these diisocyanates are one or more selected from the group consisting of isophorone diisocyanate, hexamethylene diisocyanate, hydrogenated xylylene diisocyanate and hydrogenated diphenylmethane diisocyanate.

The aforementioned diisocyanates may be used intramolecularly or intermolecularly each alone or in combinations of two or more thereof.

Diol Component Having Aromatic Skeleton

As the diol having an aromatic skeleton, heretofore known diols having an aromatic skeleton can be used without imposing any particular restrictions as long as the diols have in the molecule thereof an aromatic structure. Specific examples of the diol having an aromatic skeleton include: biphenyl-4,4′-diol, 1,4-benzenediol, bisphenol A, ethylene oxide-modified bisphenol A, propylene oxide-modified bisphenol A, aromatic polycarbonate polyol and aromatic polyester polyol.

Preferable among these is aromatic polyester polyol, because of being more satisfactory in the adhesiveness to the PVC substrate. Isophthalate is more preferable among aromatic polyester polyols.

The aforementioned diols may be used intramolecularly or inter molecularly each alone or in combinations of two or more thereof.

The content of the aforementioned urethane (meth)acrylate is preferably 0.5 to 4% by mass and more preferably 1 to 3% by mass in relation to the total amount (100% by mass) of the light curable aqueous emulsion because of being more excellent in the adhesiveness to the PVC substrate and the stability after dispersion in water.

Photoradical Polymerization Initiator

The ink composition of the present embodiment includes a photoradical polymerization initiator. The photoradical polymerization initiator causes photoradical polymerization as follows: the photocleavage, hydrogen abstraction or the like due to the irradiation of the photoradical polymerization initiator with an active energy ray such as ultraviolet light produces a radical (photoradical polymerization initiator radical), and the radical attacks the urethane (meth)acrylate, the cross-linked urethane (meth)acrylate and the compound having a radical polymerizable group(s) (preferably a radical polymerizable (meth)acrylate) to cause photoradical polymerization.

The photoradical polymerization initiator is preferably a hydrophobic photopolymerization initiator because the hydrophobic photopolymerization initiator exhibits a satisfactory emulsifying dispersibility when emulsified and dispersed in water with the urethane (meth)acrylate.

The hydrophobic photopolymerization initiator is not particularly limited; however, specific examples of the hydrophobic photopolymerization initiator include: acetophenone, 2,2-diethoxyacetophenone, p-dimethylaminoacetophenone, benzophenone, 2-chlorobenzophenone, p,p′-dichlorobenzophenone, p,p′-bisdiethylaminobenzophenone, Michler's ketone, benzil, benzoin, benzoin methyl ether, benzoin ethyl ether, benzoin isopropyl ether, benzoin n-propyl ether, benzoin isobutyl ether, benzoin n-butyl ether, benzyl methyl ketal, 2,2-dimethoxy-1,2-diphenylethan-1-one, 1-hydroxycyclohexyl phenyl ketone, 2-hydroxy-1-{4-[4-(2-hydroxy-2-methylpropionyl)benzyl]phenyl}-2-methylpropan-1-one, 2-benzyl-2-dimethylamino-1-(4-morpholinophenyl)butanone-1,2-dimethylamino-2-(4-methylbenzyl)-1-(4-morpholin-4-yl-phenyl)butan-1-one, 2,4,6-trimethylbenzoyl diphenyl phosphine oxide, bis(2,4,6-trimethylbenzoyl)phenyl phosphine oxide, bis(2,6-dimethoxybenzoyl)-2,4,4-trimethylpentyl phosphine oxide, 2-methyl-1-[4-(methylthio)phenyl]-2-morpholinopropan-1-one, thioxanthone, 2-chlorothioxanthone, 2-methylthioxanthone, 2-isopropylthioxanthone, 4-isopropylthioxanthone, 2-hydroxy-2-methyl-1-phenyl-1-one, 1-(4-isopropylphenyl)-2-hydroxy-2-methylpropan-1-one, methyl benzoyl formate, azobisisobutylonitrile, benzoyl peroxide and di-tert-butyl peroxide.

Examples of the commercially available product of the photoradical polymerization initiator include: IRGACURE 651 (2,2-dimethoxy-1,2-diphenylethan-1-one), IRGACURE 184 (1-hydroxy-cyclohexyl-phenyl-ketone), DAROCUR 1173 (2-hydroxy-2-methyl-1-phenyl-propan-1-one), IRGACURE 2959 (1-[4-(2-hydroxyethoxy)-phenyl]-2-hydroxy-2-methyl-1-propan-1-one), IRGACURE 127 (2-hydrorxy-1-{4-[4-(2-hydroxy-2-methyl-propionyl)-benzyl]phenyl-2-methyl-propan-1-one}, IRGACURE 907 (2-methyl-1-(4-methylthiophenyl)-2-morpholinopropan-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), Speedcure TPO (2,4,6-trimethylbenzoyl-diphenyl-phosphine oxide), IRGACURE 819 (bis(2,4,6-trimethylbenzoyl)-phenylphosphine oxide), IRGACURE 784 (bis(η5-2,4-cyclopentadien-1-yl)-bis(2,6-difluoro-3-(1H-pyrrol-1-yl)-phenyl) titanium), IRGACURE OXE 01 (1,2-octanedione-1-[4-(phenylthio)-2-(O-benzoyloxime)]), IRGACURE OXE 02 (ethanone, 1-[9-ethyl-6-(2-methylbenzoyl)-9H-carbazol-3-yl]-, 1-(O-acetyloxime)), IRGACURE 754 (mixture of oxyphenylacetic acid 2-[2-oxo-2-phenylacetoxyethoxy]ethyl ester and oxyphenylacetic acid 2-(2-hydroxyethoxy)ethyl ester) (the foregoing, manufactured by BASF Corp.); DETX-S (2,4-diethylthioxanthone (manufactured by Nippon Kayaku Co., Ltd.); Lucirin TPO, LR8893 and LR8970 (the foregoing, manufactured by BASF Corp.); and Ubecryl P36 (manufactured by UCB Co., Ltd.).

In the ink composition in which pigments are used as colorants, because even the deep portion of the coating film can be cured by using longer wavelength ultraviolet light in a wavelength range from 360 to 410 nm, acylphosphine oxide-based compounds exhibiting absorption in this wavelength range are preferably used. Specific examples of such compounds include: 2,4,6-trimethylbenzoyl-diphenyl-phosphine oxide (DAROCUR TPO, manufactured by BASF Corp.), Speedcure TPO (manufactured by Lambson Group Ltd.) and bis(2,4,6-trimethylbenzoyl)-phenylphosphine oxide (IRGACURE 819, manufactured by BASF Corp.).

The photoradical polymerization initiators may be used each alone or in combinations of two or more thereof. The photoradical polymerization initiator is included in a content of 0.1 to 10% by mass and more preferably 0.5 to 8% by mass in relation to the total amount (100% by mass) of the ink composition. The aforementioned range results in satisfactory curability.

In particular, when two or more photoradical polymerization initiators are used, such initiators preferably include at least a thioxanthone-based photoradical polymerization initiator, and more preferably includes both of a phenylphosphine-based photoradical polymerization initiator and a thioxanthone-based photoradical polymerization initiator. In this case, because the thioxanthone-based photoradical polymerization initiator is excellent in sensitization effect, the curability is made more excellent.

The thioxanthone-based photoradical polymerization initiator is not particularly limited; however, examples of such an initiator include thioxanthone, 2-methylthioxanthone, 2,4-diethylthioxanthone, 2-isopropylthioxanthone, 4-isopropylthioxanthone, 2-chlorothioxanthone and 2,4-diethylthioxanthone.

Examples of the commercially available product of the thioxanthone-based photoradical polymerization initiator include: KAYACURE DETX-S (trade name of 2,4-diethylthioxanthone, manufactured by Nippon Kayaku Co., Ltd.), Speedcure DETX (trade name of 2,4-diethylthioxanthone, manufactured by Lambson Ltd.) and KAYACURE ITX (trade name of 2-/4-isopropylthioxanthone, manufactured by Nippon Kayaku Co., Ltd.).

Fluorescent Brightening Agent

The aforementioned light curable aqueous emulsion preferably further includes a fluorescent brightening agent in addition to the photoradical polymerization initiator. Thus, the curability is made more excellent.

The fluorescent brightening agent is classified as a sensitizer. The fluorescent brightening agent is a colorless or slightly colored compound capable of absorbing light having a peak wavelength approximately in a range from near ultraviolet to short wavelength visible light, namely, a wavelength range from 300 to 450 nm and capable of emitting fluorescence having a peak wavelength approximately in a range from 400 to 500 nm. The fluorescent brightening agent is also known as the fluorescent whitening agent. The physical principles and the chemical properties of the fluorescent brightening agent is described in Ullmann's Encyclopedia of Industrial Chemistry, Sixth Edition, Electronic Release, Wiley-VCH, 1998.

The fluorescent brightening agent is excited to an excited state with an active energy ray and can accelerate the generation of useful groups such as radicals and acids the interactions such as energy transfer and electron transfer with other substances such as radical generating agents and acid generating agents. Examples of the case of the occurrence of such interactions include a case where the energy level of the triplet excited state of the fluorescent brightening agent molecule and the energy level of the triplet excited state of the radical generating agent or the acid generating agent are extremely close to each other, and additionally, the energy level of the triplet excited state of the radical generating agent or the acid generating agent is slightly lower than the energy level of the triplet excited state of the fluorescent brightening agent. Actually, it is required that the fluorescent brightening agent be capable of capturing the irradiation light in a wavelength band of from 350 nm to 450 nm, and additionally, the energy level of the triplet excited state of the fluorescent brightening agent have the aforementioned specific relation with the energy level of the triplet excited state of the radical generating agent or the acid generating agent. In order to meet this requirement, it is required that the energy level of the singlet exited state and the energy level of the triplet excited state be close to each other. Accordingly, also included is the case where the fluorescent brightening agent is used from the viewpoint of the interaction with the radical generating agent or the acid generating agent, and at the same time, the absorption wavelength band of the photoradical polymerization initiator overlaps with the absorption wavelength band of the fluorescent brightening agent from the viewpoint of the generation efficiency, as the ink liquid, of the radical or acid with respect to the irradiation wavelength. In this case, the fluorescent brightening agent in the present embodiment has an absorption region in the wavelength band at least partially overlapping with the absorption wavelength band of the photopolymerization initiator, capable of performing cleavage thereof.

The fluorescent brightening agent is not particularly limited; however, examples of the fluorescent brightening agent include: naphthalene benzoxazolyl derivatives, thiophene benzoxazolyl derivatives, stilbene benzoxazolyl derivatives, coumarin derivatives, styrene biphenyl derivatives, pyrazolone derivatives, stilbene derivatives, styryl derivatives of benzene and biphenyl, bis(benzazol-2-yl) derivatives, carbostyrils, naphthalimides, derivatives of dibenzothiophene-5,5′-dioxide, pyrene derivatives and pyridotriazoles. These may be used each alone or in combinations of two or more thereof.

Examples of the commercially available product of the fluorescent brightening agent include TINOPAL OB manufactured by BASF Corp. and HOSTALUX KCB (1,4-bis(2-benzoxazolyl)naphthalene) manufactured by Clariant (Japan) K.K.

The fluorescent brightening agent has a feature such that the maximum absorbance of the fluorescent brightening agent per a predetermined concentration in a wavelength band of from 360 nm to 420 nm is larger than the maximum absorbance per the same concentration as the aforementioned predetermined concentration of the photopolymerization initiator in the aforementioned wavelength band. The present inventors have found that the fulfillment of this feature results in an ink composition extremely excellent in curability. In the design method for allowing the photopolymerization initiator and the fluorescent brightening agent to fulfill the aforementioned feature, the absorption spectrum, and the maximum absorbance and the peak wavelength of the absorption spectrum of each of the photopolymerization initiator to be used and the fluorescent brightening agent to be used are analyzed. Then, it is only required to verify whether or not the relation between the maximum absorbance of the photopolymerization initiator and the maximum absorbance of the fluorescent brightening agent fulfills the aforementioned feature.

When an ultraviolet light-emitting diode (LED) is used as the light source used for measuring the absorption spectra of the fluorescent brightening agent and the photopolymerization initiator, LEDs having a light emission peak in a wavelength band of from 360 nm to 420 nm are usable. The wavelength of the LED is not limited to the wavelength in the case where a single LED is used; a plurality of LEDs may be used in combination so as for the light source to have a plurality of light emission peaks. For example, LEDs respectively having the peak wavelengths of 365 nm, 385 nm, 395 nm and 405 nm may be used in combinations of two or more thereof.

The fluorescent brightening agents may be used each alone or in combinations of two or more thereof. The fluorescent brightening agent is included preferably in a content of 0.01% by mass to 0.5% by mass in relation to the total mass (100% by mass) of the light curable aqueous emulsion. When the content falls within this range, the light curability is made satisfactory, and the effect of the fluorescent brightening agent itself possibly exerting on the hue of the cured film can be reduced.

Water

As the water used in the ink composition of the present embodiment, namely, the water as the main solvent, there can be used pure water or ultrapure water such as ion exchanged water, ultrafiltered water, reverse osmotic water and distilled water.

Other Additives

The ink composition of the present embodiment may include the additives other than the aforementioned additives. The other additives are not particularly limited; however, examples of the other additives include a wetting agent, a fungicide, a preservative, an antirust, an antioxidant, a thickener, a pH adjuster, a (fixing) resin and a surface tension adjuster.

The ink composition may also include a wetting agent. As the wetting agent, those wetting agents which are used for this type of ink composition can be used without imposing any particular restrictions. In particular, for the purpose of imparting water retentivity and wettability to the ink composition, it is preferable to use a high boiling point wetting agent having a boiling point of 180° C. or higher, preferably 200° C. or higher. The high boiling point wetting agent is not particularly limited; however, specific examples of the high boiling point wetting agent include: ethylene glycol, propylene glycol, diethylene glycol, triethylene glycol, pentaethylene glycol, trimethylene glycol, 2-butene-1,4-diol, 2-ethyl-1,3-hexanediol, 2-methyl-2,4-pentanediol, tripropylene glycol, polyethylene glycol having a molecular weight of 2000 or less, 1,3-propylene glycol, isopropylene glycol, isobutylene glycol, glycerin, mesoerythritol and pentaerythritol.

These whetting agents may be used each alone or as mixtures of two or more thereof. The addition of a high boiling point wetting agent enables to obtain an ink for ink jet capable of maintaining fluidity and redispersibility over a long period of time even when allowed to stand under an open condition (a condition that the ink is in contact with air at room temperature). Further, the addition of such a wetting agent results in an ink composition excellent in the ejection stability from the ink jet nozzles because such an ink composition leads to scarce occurrence of nozzle clogging during printing with an ink jet printer or at restarting of printing following a halting of printing with an ink jet printer.

Additionally, the use of a sugar or a sugar alcohol as the wetting agent enables to suppress the occurrence of curling and cockling.

The aforementioned sugar is not particularly limited; however, examples of the sugar include: monosaccharides, disaccharides, oligosaccharides (including trisaccharides and tetrasaccharides) and polysaccharides; preferable examples include: glucose, mannose, fructose, ribose, xylose, arabinose, galactose, aldonic acid, glucitose, maltose, cellobiose, lactose, sucrose, trehalose and maltotriose.

The aforementioned sugar alcohol is not particularly limited; however, examples of the sugar alcohol include: threitol, erythritol, arabitol, ribitol, xylitol, lyxitol, sorbitol(glucitol), mannitol, iditol, gulitol, talitol, galactitol, allitol, altritol, maltitol, isomaltitol, lactitol and turanitol.

Light Curable Aqueous Emulsion

Preferably, a light curable aqueous emulsion is formed, in the ink composition of the present embodiment, by at least either of the urethane (meth)acrylate represented by the general formula (1) and the cross-linked urethane (meth)acrylate, the compound having a radical polymerization group(s) and a radical-based photopolymerization initiator (photoradical polymerization initiator). In this case, the ink composition is excellent in curability based on irradiation of ultraviolet light in the presence of water or a solvent, and odor can be effectively suppressed. The light curable aqueous emulsion can be composed of at least either of the urethane (meth)acrylate and the cross-linked urethane (meth)acrylate, and the compound having a radical polymerizable group(s) and the photoradical polymerization initiator emulsified and dispersed in water by at least either of the concerned urethane (meth)acrylate and the concerned cross-linked urethane (meth)acrylate.

The present inventors have found that curability is made excellent by including a photoradical polymerization initiator and a radical polymerizable (meth) acrylic compound in an emulsion of an amphiphilic linear urethane (meth)acrylate. The aforementioned urethane (meth)acrylate is an amphiphilic substance, and hence adoption of a linear structure for the molecular structure of the urethane (meth)acrylate to obtain a light curable aqueous emulsion achieving advantageous effects such that the emulsion is stable and excellent in dispersibility, and is low in viscosity.

The aforementioned effects due to the light curable aqueous emulsion are probably brought about by the following reasons.

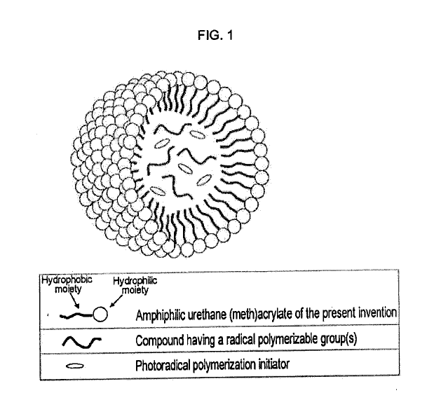

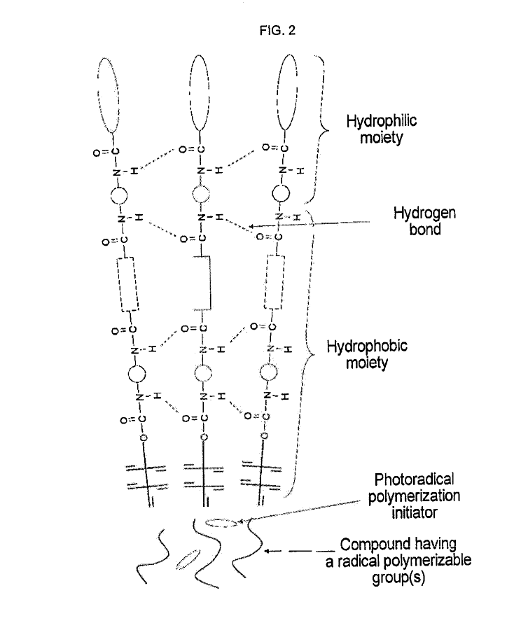

FIG. 1 is a schematic diagram macroscopically illustrating an ultraviolet curable aqueous emulsion of the light curable aqueous emulsion; and FIG. 2 is a schematic diagram microscopically illustrating the ultraviolet curable aqueous emulsion of the light curable aqueous emulsion. As shown in FIGS. 1 and 2, the urethane (meth)acrylate probably forms micelles in water in such a way that the hydrophobic moiety is directed toward the core and the hydrophilic moiety is directed toward the water phase to form the shell layer, and thus the urethane (meth)acrylate probably can form in water micelles including the compound having a radical polymerizable group(s) (preferably radical polymerizable (meth)acrylate) and the photoradical polymerization initiator.

Such a micelle formation as described above is probably ascribable to the molecular structure of the urethane (meth)acrylate. Specifically, in the micelle formation, the molecular structure of the urethane (meth)acrylate is smaller in steric hindrance as compared to the case where the main chain is branched or the main chain has hydrophobic moieties at both terminals thereof, and is probably free from bend conformation. Accordingly, it becomes possible that the urethane (meth)acrylate is regularly densely oriented with the hydrophilic moiety directed toward the water phase. Thus, in the micelle in which the urethane (meth)acrylate molecules are densely oriented, the hydrogen bonds between the urethane bonds operate effectively to increase the micelle formation strength (packing property) so as to probably contribute to the stability and the dispersibility of the micelles.

Probably thus, the light curable aqueous emulsion is excellent in stability and a satisfactory photopolymerizability is obtained even when the compound having a radical polymerization group(s) (preferably, radical polymerizable (meth)acrylate) and the photoradical polymerization initiator are included in the micelles.

As for the light curable aqueous emulsion, a person having ordinary skill in the art may select appropriate methods by appropriately improving and modifying the methods performed in the below described examples; thus, heretofore known methods such as emulsion polymerization, high pressure emulsification and phase inversion emulsification may be adopted. Within the range not impairing the advantageous effects of the present invention, heretofore known various emulsifying agents and dispersing agents may also be used where necessary.

The emulsion polymerization is a method in which an amphiphilic substance such as a surfactant is added in the water phase, and then an oil phase is added to the water phase. The high pressure emulsification method is a method in which a water phase, an oil phase and an amphiphilic substance such as a surfactant are preliminarily mixed, and the resulting mixture is emulsified with a high pressure emulsifying machine such as a homogenizer to yield an aqueous emulsion. The inversion emulsification method is a method in which an amphiphilic substance such as a surfactant is dissolved or dispersed in an oil phase, and a water phase is added to the oil phase to yield an O/W type emulsion. The continuous phase is inverted from water to oil (inverse phase) midway through the emulsification, and hence this emulsification is referred to as the phase inversion emulsification. In this connection, the aforementioned surfactant is not limited to the following examples; however, examples of such a surfactant include: sodium alkylsulfonate, alkyl sulfate ester sodium, alkyl ether sulfate ester sodium, polyoxyethylene alkyl ether, polyoxyethylene alkyl phenyl ether, alkylamino fatty acid sodium salt and alkyl trimethyl ammonium salt.

In the ink composition of the present embodiment, when at least either of the urethane (meth)acrylate represented by the general formula (1) and the cross-linked urethane (meth)acrylate, the compound having a radical polymerizable group(s) and the radical-based photopolymerization initiator (photoradical polymerization initiator) constitute the light curable aqueous emulsion, the average particle size of the emulsion is preferably 30 to 2,000 nm and more preferably 50 to 1,000 nm. The average particle size of the light curable aqueous emulsion falling within the aforementioned range makes the ejection stability more satisfactory.

The average particle size of the light curable aqueous emulsion can be regulated by varying the molecular sizes of the urethane (meth)acrylate represented by the general formula (1) and the cross-linked urethane (meth)acrylate. Accordingly, the starting materials of the urethane (meth)acrylate represented by the general formula (1) and the cross-linked urethane (meth)acrylate may be appropriately varied. The average particle size of the light curable aqueous emulsion can also be regulated by a heretofore known method; for example, the stirring speed, the emulsifying agent or the like in preparation of the light curable aqueous emulsion may be appropriately improved or varied.

The average particle size in the present specification means the particle size at cumulative 50% by volume and is measured by dynamic light scattering. The average particle size can be measured, for example, by using the Microtrac UPA150 (trade name, manufactured by Microtrac Inc.).

When the light curable aqueous emulsion is prepared by using the aforementioned cross-linked urethane (meth)acrylate, either of the emulsion formation and the cross-linking reaction may come first. In particular, when the cross-linking reaction follows the establishment of the emulsified condition, gelification can be effectively prevented; hence, it is preferable to perform the cross-linking reaction in the emulsion condition following emulsification.

The counterpart of the cross-linking reaction based on the cross-linking agent is not limited to the urethane (meth)acrylate represented by the foregoing general formula (1), but may also be other included substances such as the aforementioned compound having in the molecule thereof three or more (meth)acryloyl groups.

As described above, the ink composition including the light curable aqueous emulsion using the urethane (meth)acrylate is low in viscosity, excellent in curability, light curable in the presence of water, and additionally excellent in hydrolysis resistance. In particular, in the form in which the compound having a radical polymerizable group(s) and the photoradical polymerization initiator are included in the micelles formed by the aforementioned urethane (meth)acrylate, the concerned light curable aqueous emulsion can acquire the excellent curability and the performance of being light curable even in the presence of a predetermined concentration of water, wherein such performance is not found in conventional light curable aqueous emulsions. The urethane (meth)acrylate forming the micelles of the light curable aqueous emulsion is capable of densely orienting due to the structure thereof, and further strong bonding force due to hydrogen bond probably operates between the arranged urethane (meth)acrylate molecules because the urethane (meth)acrylate has the urethane bonds (urethane groups) in the hydrophobic moiety in the structure thereof. Probably because of this, there has been obtained a stable emulsion in which the included substances in the micelles hardly leak and hydrolysis hardly occurs.

The reasons for the fact that the light curable aqueous emulsion is excellent in photopolymerizability (curability) and additionally is polymerized (cured) with light even in the presence of a predetermined concentration of water are not yet clear; however, the reasons are inferred as follows. As described above, the light curable aqueous emulsion takes the condition such that the aforementioned urethane (meth)acrylate forms in water spherical micelles including in the core thereof the compound having a radical polymerizable group(s) and the photoradical polymerization initiator; in this condition, light irradiation does not cause polymerization (curing). When the light curable aqueous emulsion is applied to a recording medium and dried so as to have a predetermined concentration, light irradiation can cause polymerization (curing) even in the condition such that water remains, and thus a satisfactory adhesion to the recording medium can be obtained. This is presumably because the decrease of the water concentration allows the spherical micelles to form a lamellar structure under the condition that the spherical micelles hold in the interior thereof the compound having a radical polymerizable group(s) and the photoradical polymerization initiator; and irradiation of the lamellar structure with light allows the photoradical polymerization initiator in the interior of the lamellar structure to be the initiator radical, and the initiator radical attacks the compound having a radical polymerizable group(s) and the acryloyl group of the urethane (meth)acrylate to cause a chain reaction. This presumption is made for the purpose of describing the curability of the light curable aqueous emulsion, but is not construed to limit the light curable aqueous emulsion in the present embodiment.

Production Method of Ink Composition for Ink Jet

The ink composition of the present embodiment can be obtained by mixing a pigment, a water-soluble organic solvent, a surfactant, at least either of the urethane (meth)acrylate represented by the foregoing general formula (1) having a weight average molecular weight of 1,000 to 10,000 and the cross-linked product of the concerned urethane (meth)acrylate, the compound having a radical polymerizable group(s), the photoradical polymerization initiator and water. Among the aforementioned substances, the urethane (meth)acrylate, the compound having a radical polymerizable group(s) and the photoradical polymerization initiator preferably form a light curable aqueous emulsion as described above.

When the ink composition of the present embodiment uses the light curable aqueous emulsion including at least either of the urethane (meth)acrylate and the cross-linked urethane (meth)acrylate, the compound having a radical polymerizable group(s) and the photoradical polymerization initiator, the mass ratio between the content of the nonvolatile component (solid content) of the light curable aqueous emulsion and the content of the solid content of the pigment can be set at 1:1 to 100:1. The mass ratio made to fall within this range provides advantageous effects such that a coating film excellent in film strength and adhesiveness can be obtained independently of the concentration of the pigment included in the ink, and additionally an ink excellent in ejection stability can be obtained. Preferably, the mass ratio made to fall within the range from 3:1 to 70:1 enables to more improve the aforementioned advantageous effects.

As described above, according to the present embodiment, there can be obtain an ink composition for ink jet excellent in the curability based on the ultraviolet irradiation, in the ejection stability with respect to the factors such as dot loss or flight deflection, and in the storage stability. Moreover, the ink composition for ink jet realizes high speed printing and low viscosity, and is additionally excellent in safety and adaptability to recording medium.

Recorded Matter

An embodiment of the present invention relates to recorded matter. The recorded matter is obtained by making recording on a recording medium with the ink composition of the aforementioned embodiment, and includes the recording medium and the cured product of the ink composition recorded on the recording medium. The recorded matter has a feature of being excellent in abrasion resistance and gas resistance.

The recording medium is not particularly limited; however, examples of the recording medium include: plastic substrates (plates, films and molded articles) made of polymers such as polyvinyl chloride (PVC), polyethylene, polypropylene and polyethylene terephthalate (PET); metal plates made of metals such as iron, silver, copper and aluminum; metal plates and plastic films prepared by vapor deposition of these various metals; plates made of alloys such as stainless steel and brass; and ceramics. High-quality paper and paper used in running on, and various paper media are also preferably usable.

Ink Jet Recording Method

An embodiment of the present invention relates to an ink jet recording method. The ink jet recording method includes: an ejection step of ejecting the ink composition of the aforementioned embodiment onto a recording medium; and a curing step of curing the ink composition by irradiating the ink composition ejected by the ejection step with an active radiation having a light emission peak wavelength within a predetermined range. A cured film (coating film) is formed of the ink composition thus cured on the recording medium. Hereinafter, the aforementioned steps are described in detail.

Ejection Step

In the ejection step, heretofore known ink jet recording devices can be used. In the ejection of the ink composition, the viscosity of the ink composition is preferably set at 30 mPa·s or less and more preferably set at 2 to 25 mPa·s. The viscosity of the ink composition falling within the aforementioned range realizes a satisfactory ejection stability.

Curing Step

Next, in the curing step, the ink composition ejected on the recording medium is cured with irradiation of a radiation (light).

Specifically, the irradiation of a radiation initiates the polymerization reaction of the polymerizable compound. The irradiation of a radiation also decomposes the photoradical polymerization initiator included in the ink composition to generate initiating species such as a radical, an acid and a base, and thus the functions of the initiating species accelerate the polymerization reaction of the polymerizable compound. In this case, when a sensitizing dye is present together with the photoradical polymerization initiator in the ink composition, the sensitizing dye in the system absorbs the active radiation to be excited to an excited state, the contact of the excited sensitizing dye with the photoradical polymerization initiator accelerates the decomposition of the photoradical polymerization initiator to enable to achieve a higher sensitivity curing reaction.

As the light source (radiation source), mercury lamps, gas and solid lasers and the like are mainly used; mercury lamps and metal halide lamps are widely known as the light sources used for curing light curable ink compositions for ink jet. On the other hand, nowadays from the viewpoint of environmental protection, mercury-free light sources are strongly demanded; replacement of mercury lamps with GaN-based semiconductor ultraviolet light emitting devices is industrially and environmentally extremely useful. Moreover, ultraviolet light-emitting diodes (UV-LEDs) and ultraviolet laser diodes (UV-LDs) are small in size, long in operating life, high in efficiency and low in cost, and accordingly are expected as light sources for light curable ink jet. Among these, UV-LEDs are preferable.

Here is used an ink composition capable of being cured with irradiation of a radiation having a light emission peak preferably falling in a range from 360 to 420 nm. The irradiation energy is preferably 500 mJ/cm² or less.

In the aforementioned case, low-energy and high-speed curing is made possible due to the chemical composition of the ink composition of the aforementioned embodiment. The irradiation energy is calculated by multiplying the irradiation time by the irradiation intensity. The chemical composition of the ink composition of the aforementioned embodiment enables to shorten the irradiation time, herewith leading to the increase of the recording speed. On the other hand, the chemical composition of the ink composition of the aforementioned embodiment also enables to reduce the irradiation intensity, herewith leading to the realization of device size reduction and cost decrease. In this connection, it is preferable to use UV-LEDs for irradiation of a radiation. Such an ink composition is obtained by including in the ink composition a photoradical polymerization initiator to be decomposed with irradiation of a radiation falling within the aforementioned wavelength range and a polymerizable compound to initiate the polymerization with irradiation of a radiation falling within the aforementioned wavelength range. The aforementioned wavelength range may include a single light emission peak or two or more light emission peaks. Even when two or more light emission peaks are included, the total irradiation energy of the radiations having aforementioned light emission peak wavelengths is defined as the aforementioned irradiation energy.

As described above, the present embodiment can provide an ink jet recording method excellent in the curability based on ultraviolet irradiation in the presence of water or a solvent and in the ejection stability with respect to the factors such as dot loss or flight deflection.

### EXAMPLES

Hereinafter, the embodiments of the present invention are more specifically described with reference to Examples, but the embodiments of present invention are not limited only to these Examples.

Materials Used

Synthesis Materials for Urethane Acrylate

A: Hydroxyl group-containing acrylates
Polypropylene glycol monoacrylate having a weight average molecular weight of 400 (trade name: Blenmer AP-400, manufactured by NOF Corp.) (hereinafter, referred to as “PPG acrylate”)
Pentaerythritol triacrylate (trade name: Aronix M-305, manufactured by Toagosei Co., Ltd.)
Dipentaerythritol pentaacrylate, dipentaerythritol hexaacrylate (trade name: Aronix M-403, manufactured by Toagosei Co., Ltd., the content of dipentaerythritol pentaacrylate: 50 to 60% by mass)

B: Diisocyanate
Isophorone diisocyanate (hereinafter, referred to as “IPDI”) C: Diol of acyclic hydrocarbon or alicyclic hydrocarbon having 6 to 20 carbon atoms
1,12-Dodecanediol and polypropylene glycol having a weight average molecular weight of 400 (trade name: Uniol D-400, manufactured by NOF Corp.)

D: Polyoxyalkylene glycol monoalkyl ethers
Polyethylene glycol monomethyl ether having a weight average molecular weight of 400 (trade name: methoxy PEG 400, manufactured by Toho Chemical Industry Co., Ltd.) (hereinafter, referred to as “methoxy PEG 400”)
Polyethylene glycol monomethyl ether having a weight average molecular weight of 1000 (trade name: methoxy PEG 1000, manufactured by Toho Chemical Industry Co., Ltd.) (hereinafter, referred to as “methoxy PEG 1000”)
Polyethylene glycol monomethyl ether having a weight average molecular weight of 2000 (trade name: Uniox M-2000, manufactured by NOF Corp.) (hereinafter, also referred to as “methoxy PEG 2000”)

Synthesis Material for Cross-linked Urethane Acrylate

In addition to the above-listed compounds, as a cross-linking agent, pentaerythritol tetrakis-3-mercaptopropionate (cross-linking thiol, hereinafter also referred to as “PEMP”) was used.

Compounds Having Radical Polymerizable Group(s)
Dipentaerythritol pentaacrylate, dipentaerythritol hexaacrylate (trade name: Aronix M-403, manufactured by Toagosei Co., Ltd., the content of dipentaerythritol pentaacrylate: 50 to 60% by mass)
Polypentaerythritol polyacrylate (trade name: Viscoat 802, manufactured by Osaka Organic Chemical Ind., Ltd.)
Dendrimer acrylate (trade name: Viscoat 1000, manufactured by Osaka Organic Chemical Ind., Ltd.)
Decafunctional urethane acrylate (trade name: KU-DPU, Arakawa Chemical Industries, Ltd.)
Urethane acrylate for fixing (for production method, see below-described Production Example 1)

Photoradical Polymerization Initiators
Acylphosphine oxide-based photopolymerization initiator (trade name: DAROCUR TPO, manufactured by BASF Corp.) (hereinafter, also referred to as “TPO”)
Thioxanthone-based photopolymerization initiator (trade name: Speedcure DETX, manufactured by manufactured by Lambson Ltd.) (hereinafter, simply referred to as “DETX”)

Fluorescent Brightening Agent
1,4-Bis(2-benzoxazolyl)naphthalene (trade name: HOSTALUX KCB, manufactured by Clariant (Japan) K.K.) (hereinafter, simply referred to as “KCB”)

Pigment Dispersions
Cab-o-jet-260M (self-dispersed magenta pigment dispersion, solid content concentration: 9.96% by mass, manufactured by Cabot Corp.)
Cab-o-jet-300 (self-dispersed black pigment dispersion, solid content concentration: 15% by mass, manufactured by Cabot Corp.)

Water-Soluble Organic Solvents
2-Pyrrolidone.triethylene glycol.triethylene glycol monobutyl ether (hereinafter, also referred to as “TEGmBE”)
Propylene glycol
1,2-Hexanediol

Surfactants
Polyether-modified organosiloxane (trade name: BYK-348, manufactured by Byk-Chemie Japan Co., Ltd.)
Polyether-modified polydimethylsiloxane (trade name: BYK-333, manufactured by Byk-Chemie Japan Co., Ltd.)

Structure and Synthesis of Urethane Acrylates

Structure of Urethane Acrylates

The urethane acrylates used in following Examples and Comparative Examples are the urethane acrylates having respectively the structures represented by the foregoing general formula (1) and the following general formulas (3), (4) and (5):

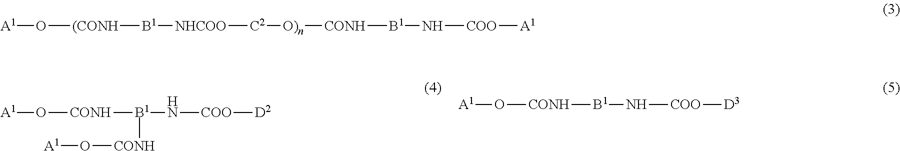

wherein A¹ represents a structure derived from a hydroxyl group-containing acrylate having one or more acryloyl groups, B¹ represents a structure derived from diisocyanate, C² represents a structure derived from diol, and D² and D³ each represent a structure derived from a polyoxyethylene glycol with one terminal thereof blocked with a methyl group (hereinafter, also referred to as polyoxyethylene glycol monomethyl ether), of the compounds represented by the foregoing general formula (2).

### Synthesis of Amphiphilic Urethane Acrylates

### Synthesis Example 1

### Synthesis of Amphiphilic Urethane Acrylate (a)

In a reaction vessel equipped with a stirrer, a condenser tube, a dropping funnel and an air introduction tube, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 200.0 parts by mass of methoxy PEG 400, 200.0 parts by mass of methoxy PEG 1000 and 0.42 part by mass of tin octylate were added to the reaction mixture, and the resulting mixture was allowed to react further for 1.5 hours. Next, in the reaction vessel, 634.3 parts by mass of PPG acrylate, 0.84 part by mass of methoquinone (hydroquinone monomethyl ether) and 0.67 part by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (a) represented by the foregoing general formula (1). The weight average molecular weight of the urethane acrylate (a) was found to be 3,200.

### Synthesis Example 2

### Synthesis of Amphiphilic Urethane Acrylate (b)

In the same reaction vessel as in Synthesis Example 1, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 200.0 parts by mass of methoxy PEG 400, 200.0 parts by mass of methoxy PEG 1000 and 0.42 part by mass of tin octylate were added to the reaction mixture, and the resulting mixture was allowed to react further for 1.5 hours. Next, in the reaction vessel, 594.4 parts by mass of pentaerythritol triacrylate, 0.82 part by mass of methoquinone and 0.66 part by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (b) represented by the foregoing general formula (1). The weight average molecular weight of the urethane acrylate (b) was found to be 3,800.

### Synthesis Example 3

### Synthesis of Amphiphilic Urethane Acrylate (c)

In the same reaction vessel as in Synthesis Example 1, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 200.0 parts by mass of methoxy PEG 400, 200.0 parts by mass of methoxy PEG 1000 and 0.42 part by mass of tin octylate were added to the reaction mixture, and the resulting mixture was allowed to react further for 1.5 hours. Next, in the reaction vessel, 1300.0 parts by mass of dipentaerythritol pentaacrylate, 1.17 parts by mass of methoquinone and 0.94 part by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (c) represented by the foregoing general formula (1). The weight average molecular weight of the urethane acrylate (c) was found to be 5,300.

### Synthesis Example 4

### Synthesis of Amphiphilic Urethane Acrylate (d)

In the same reaction vessel as in Synthesis Example 1, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 700.0 parts by mass of methoxy PEG 1000 and 0.54 part by mass of tin octylate were added to the reaction mixture, and the resulting mixture was allowed to react further for 1.5 hours. Next, in the reaction vessel, 1300.0 parts by mass of dipentaerythritol pentaacrylate, 1.32 parts by mass of methoquinone and 1.06 parts by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (d) represented by the foregoing general formula (1). The weight average molecular weight of the urethane acrylate (d) was found to be 5,600.

### Synthesis Example X: Synthesis of Amphiphilic Urethane Acrylate (e)

In the same reaction vessel as in Synthesis Example 1, 444.6 parts by mass (2 moles) of IPDI and 400.0 parts by mass of polypropylene glycol having a weight average molecular weight of 400 were placed, and while the resulting mixture was being stirred, 0.34 part by mass of tin octylate was added to the mixture, the temperature inside the reaction vessel was increased to 90° C., and the resulting mixture was allowed to react for 1.5 hours. Then, 1400.0 parts by mass of methoxy PEG 2000 and 0.90 part by mass of tin octylate were added to the reaction mixture, and the resulting mixture was allowed to react further for 1.5 hours. Next, in the reaction vessel, 1300.0 parts by mass of dipentaerythritol pentaacrylate, 1.77 parts by mass of methoquinone and 2.13 parts by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (e) represented by the foregoing general formula (1). The weight average molecular weight of the urethane acrylate (e) was found to be 9,000.

### Synthesis Example 5

### Synthesis of Urethane Acrylate (p)

In the same reaction vessel as in Synthesis Example 1, 444.6 parts by mass of IPDI and 1000.0 parts by mass of polyethylene glycol (PEG 1000, manufactured by NOF Corp.) were placed, and while the resulting mixture was being stirred, 0.58 part by mass of tin octylate was added to the mixture, the temperature inside the reaction vessel was increased to 90° C., and the resulting mixture was allowed to react for 1.5 hours. Then, 2400.0 parts by mass of dipentaerythritol pentaacrylate, 1.92 parts by mass of methoquinone and 1.54 parts by mass of tin octylate were placed in the reaction vessel and mixed, and under air bubbling, the temperature inside the reaction vessel was increased to 85° C. and the resulting mixture was allowed to react for 3 hours. Then, the reaction mixture was cooled to yield the urethane acrylate (p). The urethane acrylate (p) is a urethane acrylate in which both terminal groups are each an acryloyl group, and is represented by the foregoing general formula (3). The weight average molecular weight of the urethane acrylate (p) was found to be 10,500.

### Synthesis Example 6

### Synthesis of Urethane Acrylate (q)

In the same reaction vessel as in Synthesis Example 1, 578.0 parts by mass of the trimer of HMDI (coronate HXR, manufactured by Nippon Polyurethane Industry Co., Ltd.), 200.0 parts by mass of methoxy PEG 400 and 200.0 parts by mass of methoxy PEG 1000 were placed, and while the resulting mixture was being stirred, 0.39 part by mass of tin octylate was added to the mixture, the temperature inside the reaction vessel was increased to 75° C., and the resulting mixture was allowed to react for 1.5 hours. Then, 1051.6 parts by mass of pentaerythritol triacrylate, 1.01 parts by mass of methoquinone and 0.81 part by mass of tin octylate were placed in the reaction vessel and mixed, and under air bubbling, the temperature inside the reaction vessel was increased to 80° C. and the resulting mixture was allowed to react for 2 hours. Then, the reaction mixture was cooled to yield the amphiphilic urethane acrylate (q). The urethane acrylate (q) is a urethane acrylate in which one terminal group is an acryloyl group and for which a trifunctional isocyanate was used, and is represented by the foregoing general formula (4). The weight average molecular weight of the urethane acrylate (q) was found to be 7,400.

### Synthesis Example 7

### Synthesis of Urethane Acrylate (s)

In the same reaction vessel as in Synthesis Example 1, 444.6 parts by mass (2 moles) of IPDI and 62.1 parts by mass (1 mole) of ethylene glycol were placed, and while the resulting mixture was being stirred, 0.20 part by mass of tin octylate was added to the mixture, the temperature inside the reaction vessel was increased to 90° C., and the resulting mixture was allowed to react for 1.5 hours. Then, 700.0 parts by mass (1 mole) of methoxy PEG 1000 and 0.48 part by mass of tin octylate were added to the reaction mixture, and the resulting mixture was allowed to react further for 1.5 hours. Then, 634.3 parts by mass (1.6 moles) of PPG acrylate, 0.92 parts by mass of methoquinone and 0.68 part by mass of tin octylate were placed in the reaction vessel and mixed, and under air bubbling, the temperature inside the reaction vessel was increased to 85° C. and the resulting mixture was allowed to react for 3 hours. Then, the reaction mixture was cooled to yield the urethane acrylate (s) having a structure analogous to the structure represented by the foregoing general formula (1). Specifically, the urethane acrylate (s) has a structure analogous to the structure represented by the foregoing general formula (1) in the sense that the urethane acrylate (s) is a urethane acrylate in which the number of carbon atoms in “C¹” in the foregoing general formula (1) is 2, but the urethane acrylate (s) does not have the structure itself represented by the general formula (1). The weight average molecular weight of the urethane acrylate (s) was found to be 3,000.

### Synthesis Example 8

### Synthesis of Urethane Acrylate (t)

In the same reaction vessel as in Synthesis Example 1, 222.3 parts by mass (1 mole) of IPDI and 700.0 parts by mass (0.7 mole) of methoxy PEG 1000 were placed, and while the resulting mixture was being stirred, 0.48 part by mass of tin octylate was added to the mixture, the temperature inside the reaction vessel was increased to 90° C., and the resulting mixture was allowed to react for 1.5 hours. Then, 634.3 parts by mass (1.6 moles) of PPG acrylate, 0.78 part by mass of methoquinone and 0.62 part by mass of tin octylate were added in the reaction vessel and mixed, and under air bubbling, the temperature inside the reaction vessel was increased to 85° C. and the resulting mixture was allowed to react for 3 hours. Then, the reaction mixture was cooled to yield the urethane acrylate (t) represented by the foregoing general formula (1). The urethane acrylate (t) is a urethane acrylate free from diol residues. The weight average molecular weight of the urethane acrylate (t) was found to be 2,300.

### Production Example 1

### Synthesis of Urethane Acrylate for Fixing

In the same reaction vessel as in Synthesis Example 1, 444.6 parts by mass (2 moles) of IPDI and 900.0 parts by mass (1 mole) of an aromatic polyester diol (weight average molecular weight: 900, trade name: YG-108, manufactured by Adeka Corp.) were placed, and while the resulting mixture was being stirred, 0.27 part by mass of tin octylate was added to the mixture, the temperature inside the reaction vessel was increased to 85° C., and the resulting mixture was allowed to react for 2 hours. Then, 232.3 parts by mass (2 moles) of 2-hydroxyethyl acrylate, 0.79 part by mass of methoquinone and 0.63 part by mass of tin octylate were placed in the reaction vessel and mixed, and under air bubbling, the temperature inside the reaction vessel was increased to 85° C. and the resulting mixture was allowed to react for 2 hours. Then, the reaction mixture was cooled to yield the urethane acrylate for fixing. The weight average molecular weight of the urethane acrylate for fixing was found to be 5,000.

### Preparation of Light Curable Aqueous Emulsions

Hereinafter, the preparation methods of light curable aqueous emulsions are described.

### Synthesis Example 9

### Preparation of a Light Curable Aqueous Emulsion (a-1)

In the same reaction vessel as in Synthesis Example 1, 28.5 parts by mass of the amphiphilic urethane acrylate (a) obtained above, 9.5 parts by mass of dipentaerythritol pentaacrylate and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (a-1) containing 40% of a nonvolatile content (the amphiphilic urethane acrylate (a), dipentaerythritol pentaacrylate and the photoradical polymerization initiator (TPO)). The composition of the light curable aqueous emulsion (a-1) is shown in Table 1 presented below.

### Synthesis Example 10

### Preparation of a Light Curable Aqueous Emulsion (b-1)

In the same reaction vessel as in Synthesis Example 1, 36.7 parts by mass of the amphiphilic urethane acrylate (b) obtained above and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (b-1) containing 40% of a nonvolatile content (the amphiphilic urethane acrylate (b) and the photoradical polymerization initiator (TPO)). The composition of the light curable aqueous emulsion (b-1) is shown in Table 1 presented below.

### Synthesis Example 11

### Preparation of a Light Curable Aqueous Emulsion (c-1)

In the same reaction vessel as in Synthesis Example 1, 36.7 parts by mass of the amphiphilic urethane acrylate (c) obtained above and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (c-1) containing 40% of a nonvolatile content (the amphiphilic urethane acrylate (c) and the photoradical polymerization initiator (TPO)). The composition of the light curable aqueous emulsion (c-1) is shown in Table 1 presented below.

### Synthesis Example 12

### Preparation of a Light Curable Aqueous Emulsion (d-1)

In the same reaction vessel as in Synthesis Example 1, 27.5 parts by mass of the amphiphilic urethane acrylate (d) obtained above, 9.2 parts by mass of dipentaerythritol hexaacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-1) containing 40% of a nonvolatile content (the amphiphilic urethane acrylate (d), dipentaerythritol hexaacrylate and the photoradical polymerization initiator (TPO)). The composition of the light curable aqueous emulsion (d-1) is shown in Table 1 presented below.

### Synthesis Example 13

### Preparation of a Light Curable Aqueous Emulsion (d-2)

In the same reaction vessel as in Synthesis Example 1, 27.5 parts by mass of the amphiphilic urethane acrylate (d) obtained above, 9.2 parts by mass of polypentaerythritol polyacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-2) containing 40% of a nonvolatile content (the amphiphilic urethane acrylate (d), polypentaerythritol polyacrylate and the photoradical polymerization initiator (TPO)). The composition of the light curable aqueous emulsion (d-2) is shown in Table 1 presented below.

### Synthesis Example 14

### Preparation of a Light Curable Aqueous Emulsion (d-3)

In the same reaction vessel as in Synthesis Example 1, 27.5 parts by mass of the amphiphilic urethane acrylate (d) obtained above, 9.2 parts by mass of dendrimer acrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-3) containing 40% of a nonvolatile content (the amphiphilic urethane acrylate (d), dendrimer acrylate and the photoradical polymerization initiator (TPO)). The composition of the light curable aqueous emulsion (d-3) is shown in Table 1 presented below.

### Synthesis Example 15

### Preparation of a Light Curable Aqueous Emulsion (d-4)

In the same reaction vessel as in Synthesis Example 1, 27.5 parts by mass of the amphiphilic urethane acrylate (d) obtained above, 9.2 parts by mass of decafunctional urethane acrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-4) containing 40% of a nonvolatile content (the amphiphilic urethane acrylate (d), decafunctional urethane polyacrylate and the photoradical polymerization initiator (TPO)). The composition of the light curable aqueous emulsion (d-4) is shown in Table 1 presented below.

### Synthesis Example 16

### Preparation of a Light Curable Aqueous Emulsion (p-1)

In the same reaction vessel as in Synthesis Example 1, 38.0 parts by mass of the urethane acrylate (p) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (p-1) containing 40% of a nonvolatile content (the urethane acrylate (p) and the photoradical polymerization initiator (TPO)). The composition of the light curable aqueous emulsion (p-1) is shown in Table 1 presented below.

### Synthesis Example 17

### Preparation of a Light Curable Aqueous Emulsion (q-1)

In the same reaction vessel as in Synthesis Example 1, 38.0 parts by mass of the urethane acrylate (q) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (q-1) containing 40% of a nonvolatile content (the urethane acrylate (q) and the photoradical polymerization initiator (TPO)). The composition of the light curable aqueous emulsion (q-1) is shown in Table 1 presented below.

### Synthesis Example 18

### Preparation of a Light Curable Aqueous Emulsion (q-2)

In the same reaction vessel as in Synthesis Example 1, 27.5 parts by mass of the urethane acrylate (q) obtained above, 9.2 parts by mass of polypentaerythritol polyacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (q-2) containing 40% of a nonvolatile content (the urethane acrylate (q), polypentaerythritol polyacrylate and the photoradical polymerization initiator (TPO)). The composition of the light curable aqueous emulsion (q-2) is shown in Table 1 presented below.

### Synthesis Example 19

### Preparation of a Light Curable Aqueous Emulsion (s-1)

In the same reaction vessel as in Synthesis Example 1, 38.0 parts by mass of the urethane acrylate (s) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (s-1) containing 40% of a nonvolatile content (the urethane acrylate (s) and the photoradical polymerization initiator (TPO)). The composition of the light curable aqueous emulsion (s-1) is shown in Table 1 presented below.

### Synthesis Example 20

### Preparation of a Light Curable Aqueous Emulsion (t-1)

In the same reaction vessel as in Synthesis Example 1, 38.0 parts by mass of the urethane acrylate (t) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (t-1) containing 40% of a nonvolatile content (the urethane acrylate (t) and the photoradical polymerization initiator (TPO)). The composition of the light curable aqueous emulsion (t-1) is shown in Table 1 presented below.

### Synthesis Example 21

### Preparation of a Light Curable Aqueous Emulsion (d-5)

In the same reaction vessel as in Synthesis Example 1, 27.4 parts by mass of the amphiphilic urethane acrylate (d) obtained above, 9.1 parts by mass of polypentaerythritol polyacrylate, 3.3 parts by mass of a photoradical polymerization initiator (TPO) and 0.13 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-5) containing 40% of a nonvolatile content (the amphiphilic urethane acrylate (d), polypentaerythritol polyacrylate, the photoradical polymerization initiator (TPO) and the fluorescent brightening agent (KCB)). The composition of the light curable aqueous emulsion (d-5) is shown in Table 2 presented below.

### Synthesis Example 22

### Preparation of a Light Curable Aqueous Emulsion (d-6)

In the same reaction vessel as in Synthesis Example 1, 26.2 parts by mass of the amphiphilic urethane acrylate (d) obtained above, 8.7 parts by mass of polypentaerythritol polyacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 1.7 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (d-6) containing 40% of a nonvolatile content (the amphiphilic urethane acrylate (d), polypentaerythritol polyacrylate, the photoradical polymerization initiator (TPO) and the cross-linking agent (PEMP)). The emulsion was subjected to a GPC measurement to identify a cross-linked urethane acrylate having a weight average molecular weight of 8,500. The composition of the light curable aqueous emulsion (d-6) is shown in Table 2 presented below.

### Synthesis Example 23

### Preparation of a Light Curable Aqueous Emulsion (d-7)

In the same reaction vessel as in Synthesis Example 1, 26.1 parts by mass of the amphiphilic urethane acrylate (d) obtained above, 8.7 parts by mass of polypentaerythritol polyacrylate, 3.3 parts by mass of a photoradical polymerization initiator (TPO) and 0.07 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 1.7 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (d-7) containing 40% of a nonvolatile content (the amphiphilic urethane acrylate (d), polypentaerythritol polyacrylate, the photoradical polymerization initiator (TPO), the fluorescent brightening agent (KCB) and the cross-linking agent (PEMP)). The emulsion was subjected to a GPC measurement to identify a cross-linked urethane acrylate having a weight average molecular weight of 16,000. The composition of the light curable aqueous emulsion (d-7) is shown in Table 2 presented below.

### Synthesis Example 24

### Preparation of a Light Curable Aqueous Emulsion (e-1)

In the same reaction vessel as in Synthesis Example 1, 23.3 parts by mass of the amphiphilic urethane acrylate (e) obtained above, 8.3 parts by mass of polypentaerythritol polyacrylate, 1.7 parts by mass of the urethane acrylate for fixing, 5.0 parts by mass of a photoradical polymerization initiator (TPO), 1.7 parts by mass of a photoradical polymerization initiator (DETX) and 0.07 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 50° C. for 1 hour to yield the light curable aqueous emulsion (e-1) containing 40% of a nonvolatile content (the amphiphilic urethane acrylate (e), polypentaerythritol polyacrylate, the urethane acrylate for fixing, the photoradical polymerization initiators (TPO, DETX) and the fluorescent brightening agent (KCB)). The composition of the light curable aqueous emulsion (e-1) is shown in Table 2 presented below.

### Synthesis Example 25

### Preparation of a Light Curable Aqueous Emulsion (e-2)

In the same reaction vessel as in Synthesis Example 1, 23.9 parts by mass of the amphiphilic urethane acrylate (e) obtained above, 10.3 parts by mass of polypentaerythritol polyacrylate, 3.3 parts by mass of a photoradical polymerization initiator (TPO) and 0.07 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.4 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-2) containing 40% of a nonvolatile content (the amphiphilic urethane acrylate (e), polypentaerythritol polyacrylate, the photoradical polymerization initiator (TPO), the fluorescent brightening agent (KCB) and the cross-linking agent (PEMP)). The emulsion was subjected to a GPC measurement to identify a cross-linked urethane acrylate having a weight average molecular weight of 20,000. The composition of the light curable aqueous emulsion (e-2) is shown in Table 2 presented below.

### Synthesis Example 26

### Preparation of a Light Curable Aqueous Emulsion (e-3)

In the same reaction vessel as in Synthesis Example 1, 21.6 parts by mass of the amphiphilic urethane acrylate (e) obtained above, 9.2 parts by mass of polypentaerythritol polyacrylate, 6.7 parts by mass of a photoradical polymerization initiator (TPO) and 0.06 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-3) containing 40% of a nonvolatile content (the amphiphilic urethane acrylate (e), polypentaerythritol polyacrylate, the photoradical polymerization initiator (TPO), the fluorescent brightening agent (KCB) and the cross-linking agent (PEMP)). The emulsion was subjected to a GPC measurement to identify a cross-linked urethane acrylate having a weight average molecular weight of 22,000. The composition of the light curable aqueous emulsion (e-3) is shown in Table 2 presented below.

### Synthesis Example 27

### Preparation of a Light Curable Aqueous Emulsion (e-4)

In the same reaction vessel as in Synthesis Example 1, 21.6 parts by mass of the amphiphilic urethane acrylate (e) obtained above, 9.2 parts by mass of polypentaerythritol polyacrylate, 5.0 parts by mass of a photoradical polymerization initiator (TPO), 1.7 parts by mass of a photoradical polymerization initiator (DETX) and 0.06 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-4) containing 40% of a nonvolatile content (the amphiphilic urethane acrylate (e), polypentaerythritol polyacrylate, the photoradical polymerization initiators (TPO, DETX), the fluorescent brightening agent (KCB) and the cross-linking agent (PEMP)). The emulsion was subjected to a GPC measurement to identify a cross-linked urethane acrylate having a weight average molecular weight of 22,000. The composition of the light curable aqueous emulsion (e-4) is shown in Table 2 presented below.

### Synthesis Example 28

### Preparation of a Light Curable Aqueous Emulsion (e-5)

In the same reaction vessel as in Synthesis Example 1, 21.6 parts by mass of the amphiphilic urethane acrylate (e) obtained above, 7.7 parts by mass of polypentaerythritol polyacrylate, 1.5 parts by mass of the urethane acrylate for fixing, 5.0 parts by mass of a photoradical polymerization initiator (TPO) and 1.7 parts by mass of a photoradical polymerization initiator (DETX) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-5) containing 40% of a nonvolatile content (the amphiphilic urethane acrylate (e), polypentaerythritol polyacrylate, the urethane acrylate for fixing, the photoradical polymerization initiators (TPO, DETX) and the cross-linking agent (PEMP)). The emulsion was subjected to a GPC measurement to identify a cross-linked urethane acrylate having a weight average molecular weight of 18,000. The composition of the light curable aqueous emulsion (e-5) is shown in Table 2 presented below.

### Synthesis Example 29

### Preparation of a Light Curable Aqueous Emulsion (e-6)

In the same reaction vessel as in Synthesis Example 1, 21.6 parts by mass of the amphiphilic urethane acrylate (e) obtained above, 7.7 parts by mass of polypentaerythritol polyacrylate, 1.5 parts by mass of the urethane acrylate for fixing, 5.0 parts by mass of a photoradical polymerization initiator (TPO), 1.7 parts by mass of a photoradical polymerization initiator (DETX) and 0.06 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-6) containing 40% of a nonvolatile content (the amphiphilic urethane acrylate (e), polypentaerythritol polyacrylate, the urethane acrylate for fixing, the photoradical polymerization initiators (TPO, DETX), the fluorescent brightening agent (KCB) and the cross-linking agent (PEMP)). The emulsion was subjected to a GPC measurement to identify a cross-linked urethane acrylate having a weight average molecular weight of 18,000. The composition of the light curable aqueous emulsion (e-6) is shown in Table 2 presented below.

TABLE 1

| | | Synthesis | Synthesis | Synthesis | Synthesis | Synthesis | Synthesis |
|---|---|---|---|---|---|---|---|
| | | Example | Example | Example | Example | Example | Example |
| | | 9 | 10 | 11 | 12 | 13 | 14 |
| Light curable aqueous emulsion | | a-1 | b-1 | c-1 | d-1 | d-2 | d-3 |
| Molecular structure | | Linear | Linear | Linear | Linear | Linear | Linear |
| Amphiphilic | A (Acryloyl group: 1) | 28.5 | — | — | — | — | — |
| urethane | b (Acryloyl groups: 3) | — | 36.7 | — | — | — | — |
| acrylates | c (Acryloyl groups: 5) | — | — | 36.7 | — | — | — |
| | d (Acryloyl groups: 5) | — | — | — | 27.5 | 27.5 | 27.5 |
| | p (Acryloyl groups: 10) | — | — | — | — | — | — |
| | q (Acryloyl groups: 6) | — | — | — | — | — | — |
| | s (Acryloyl groups: 1) | — | — | — | — | — | — |
| | t (Acryloyl groups: 1) | — | — | — | — | — | — |
| Radical | Aronix M-403 | 9.5 | — | — | 9.2 | — | — |
| polymerizable | Viscoat 802 | — | — | — | — | 9.2 | — |
| acrylates | Viscoat 1000 | — | — | — | — | — | 9.2 |
| | KU-DPU | — | — | — | — | — | — |
| Photoradical | TPO | 2.0 | 3.3 | 3.3 | 3.3 | 3.3 | 3.3 |
| polymerization | | | | | | | |
| initiator | | | | | | | |
| Water | Ion exchanged water | 60.0 | 60.0 | 60.0 | 60.0 | 60.0 | 60.0 |
| Total amount | | 100.0 | 100.0 | 100.0 | 100.0 | 100.0 | 100.0 |
| | | Synthesis | Synthesis | Synthesis | Synthesis | Synthesis | Synthesis |
| | | Example | Example | Example | Example | Example | Example |
| | | 15 | 16 | 17 | 18 | 19 | 20 |
| Light curable aqueous emulsion | | d-4 | p-1 | q-1 | q-2 | s-1 | t-1 |
| Molecular structure | | Linear | Linear | Branched | Branched | Linear | Linear |
| Amphiphilic | A (Acryloyl group: 1) | — | — | — | — | — | — |
| urethane | b (Acryloyl groups: 3) | — | — | — | — | — | — |
| acrylates | c (Acryloyl groups: 5) | — | — | — | — | — | — |
| | d (Acryloyl groups: 5) | 27.5 | — | — | — | — | — |
| | p (Acryloyl groups: 10) | — | 38.0 | — | — | — | — |
| | q (Acryloyl groups: 6) | — | — | 38.0 | 27.5 | — | — |
| | s (Acryloyl groups: 1) | — | — | — | — | 38.0 | — |
| | t (Acryloyl groups: 1) | — | — | — | — | — | 38.0 |
| Radical | Aronix M-403 | — | — | — | — | — | — |
| polymerizable | Viscoat 802 | — | — | — | 9.2 | — | — |
| acrylates | Viscoat 1000 | — | — | — | — | — | — |
| | KU-DPU | 9.2 | — | — | — | — | — |
| Photoradical | TPO | 3.3 | 2.0 | 2.0 | 3.3 | 2.0 | 2.0 |
| polymerization | | | | | | | |
| initiator | | | | | | | |
| Water | Ion exchanged water | 60.0 | 60.0 | 60.0 | 60.0 | 60.0 | 60.0 |

| | | | | | | |
|---|---|---|---|---|---|---|
| Total amount | 100.0 | 100.0 | 100.0 | 100.0 | 100.0 | 100.0 |

TABLE 2

| | | | Synthesis | Synthesis | Synthesis | Synthesis | Synthesis |
|---|---|---|---|---|---|---|---|
| | | | Example | Example | Example | Example | Example |
| | | | 21 | 22 | 23 | 24 | 25 |
| Light curable aqueous emulsion | | | d-5 | d-6 | d-7 | e-1 | e-2 |
| Amphiphilic urethane | | a (Acryloyl group: 1) | — | — | — | — | — |
| acrylates | | b (Acryloyl groups: 3) | — | — | — | — | — |
| | | c (Acryloyl groups: 5) | — | — | — | — | — |
| | | d (Acryloyl groups: 5) | 27.4 | 26.2 | 26.1 | — | — |
| | | e (Acryloyl groups: 5) | — | — | — | 23.3 | 23.9 |
| Cross-linking thiol | | PEMP | — | 1.7 | 1.7 | — | 2.4 |
| Included | Radical | Aronix M-403 | — | — | — | — | — |
| substances | polymerizable | Viscoat 802 | 9.1 | 8.7 | 8.7 | 8.3 | 10.3 |
| | acrylates | Viscoat 1000 | — | — | — | — | — |
| | | KU-DPU | — | — | — | — | — |
| | Fluorescent | KCB | 0.13 | — | 0.07 | 0.07 | 0.07 |
| | brightening | | | | | | |
| | agent | | | | | | |
| | Urethane acrylate for fixing | | — | — | — | 1.7 | — |
| | Photoradical | TPO | 3.3 | 3.3 | 3.3 | 5 | 3.3 |
| | polymerization | DETX | — | — | — | 1.7 | — |
| | initiators | | | | | | |
| | Water | Ion exchanged water | 60 | 60 | 60 | 60 | 60 |

| | | | | | |
|---|---|---|---|---|---|
| Total amount | 99.9 | 99.9 | 99.9 | 100.1 | 100.0 |

| | | | Synthesis | Synthesis | Synthesis | Synthesis |
|---|---|---|---|---|---|---|
| | | | Example | Example | Example | Example |
| | | | 26 | 27 | 28 | 29 |
| Light curable aqueous emulsion | | | e-3 | e-4 | e-5 | e-6 |
| Amphiphilic urethane | | a (Acryloyl group: 1) | — | — | — | — |
| acrylates | | b (Acryloyl groups: 3) | — | — | — | — |
| | | c (Acryloyl groups: 5) | — | — | — | — |
| | | d (Acryloyl groups: 5) | — | — | — | — |
| | | e (Acryloyl groups: 5) | 21.6 | 21.6 | 21.6 | 21.6 |
| Cross-linking thiol | | PEMP | 2.5 | 2.5 | 2.5 | 2.5 |
| Included | Radical | Aronix M-403 | — | — | — | — |
| substances | polymerizable | Viscoat 802 | 9.2 | 9.2 | 7.7 | 7.7 |
| | acrylates | Viscoat 1000 | — | — | — | — |
| | | KU-DPU | — | — | — | — |
| | Fluorescent | KCB | 0.06 | 0.06 | — | 0.06 |
| | brightening | | | | | |
| | agent | | | | | |

| Urethane acrylate for fixing | | — | — | 1.5 | 1.5 |
|---|---|---|---|---|---|
| Photoradical | TPO | 6.7 | 5 | 5 | 5 |
| polymerization | DETX | — | 1.7 | 1.7 | 1.7 |
| initiators | | | | | |
| Water | Ion exchanged water | 60 | 60 | 60 | 60 |

| | | | | |
|---|---|---|---|---|
| Total amount | 100.1 | 100.1 | 100.0 | 100.1 |

### Examples 1 to 18 and Comparative Examples 1 to 5

By using the aforementioned materials and the light curable aqueous emulsions obtained in aforementioned Synthesis Examples 9 to 29, ink compositions were prepared according to the chemical compositions (parts by mass) shown in Tables 3 and 4. In these tables, “%” means “percent by mass.”

TABLE 3

| | | Example | Example | Example | Example | Example | Example | Example |
|---|---|---|---|---|---|---|---|---|
| | | 1 | 2 | 3 | 4 | 5 | 6 | 7 |
| Self-dispersed pigment | | 20 | 20 | 20 | 20 | 20 | 20 | 20 |
| dispersion | | | | | | | | |
| (Cab-o-jet-260M) | | | | | | | | |
| 2-Pyrrolidone | | 5 | 5 | 5 | 5 | 5 | 5 | 5 |
| Triethylene glycol | | 3 | 3 | 3 | 3 | 3 | 3 | 3 |
| TEGmBE | | 0.8 | 0.8 | 0.8 | 0.8 | 0.8 | 0.8 | 0.8 |
| BYK-348 | | 0.3 | 0.3 | 0.3 | 0.3 | 0.3 | 0.3 | 0.3 |
| Light | a-1 (Linear) | 70 | — | — | — | — | — | — |
| curable | b-1 (Linear) | — | 70 | — | — | — | — | — |
| aqueous | c-1 (Linear) | — | — | 70 | — | — | — | — |
| emulsions | d-1 (Linear) | — | — | — | 70 | — | — | — |
| | d-2 (Linear) | — | — | — | — | 70 | — | — |
| | d-3 (Linear) | — | — | — | — | — | 70 | — |
| | d-4 (Linear) | — | — | — | — | — | — | 70 |
| | p-1 (Linear) | — | — | — | — | — | — | — |
| | q-1 (Branched) | — | — | — | — | — | — | — |
| | q-2 (Branched) | — | — | — | — | — | — | — |
| | s-1 (Linear) | — | — | — | — | — | — | — |
| | t-1 (Linear) | — | — | — | — | — | — | — |
| Water | Ion exchanged | 0.9 | 0.9 | 0.9 | 0.9 | 0.9 | 0.9 | 0.9 |
| | water | | | | | | | |

| | | | | | | | |
|---|---|---|---|---|---|---|---|
| Total amount | 100 | 100 | 100 | 100 | 100 | 100 | 100 |
| Resin content in light | 36.7% | 36.7% | 36.7% | 36.7% | 36.7% | 36.7% | 36.7% |
| curable aqueous emulsion | | | | | | | |
| TPO content in light | 3.3% | 3.3% | 3.3% | 3.3% | 3.3% | 3.3% | 3.3% |
| curable aqueous emulsion | | | | | | | |

| | | Comparative | Comparative | Comparative | Comparative | Comparative |
|---|---|---|---|---|---|---|
| | | Example | Example | Example | Example | Example |
| | | 1 | 2 | 3 | 4 | 5 |
| Self-dispersed pigment | | 20 | 20 | 20 | 20 | 20 |
| dispersion | | | | | | |
| (Cab-o-jet-260M) | | | | | | |
| 2-Pyrrolidone | | 5 | 5 | 5 | 5 | 5 |
| Triethylene glycol | | 3 | 3 | 3 | 3 | 3 |
| TEGmBE | | 0.8 | 0.8 | 0.8 | 0.8 | 0.8 |
| BYK-348 | | 0.3 | 0.3 | 0.3 | 0.3 | 0.3 |
| Light | a-1 (Linear) | — | — | — | — | — |
| curable | b-1 (Linear) | — | — | — | — | — |
| aqueous | c-1 (Linear) | — | — | — | — | — |
| emulsions | d-1 (Linear) | — | — | — | — | — |
| | d-2 (Linear) | — | — | — | — | — |
| | d-3 (Linear) | — | — | — | — | — |
| | d-4 (Linear) | — | — | — | — | — |
| | p-1 (Linear) | 68 | — | — | — | — |
| | q-1 (Branched) | — | 68 | — | — | — |
| | q-2 (Branched) | — | — | 70 | — | — |
| | s-1 (Linear) | — | — | — | 68 | — |
| | t-1 (Linear) | — | — | — | — | 68 |
| Water | Ion exchanged | 2.9 | 2.9 | 0.9 | 2.9 | 2.9 |
| | water | | | | | |

| | | | | | |
|---|---|---|---|---|---|
| Total amount | 100 | 100 | 100 | 100 | 100 |
| Resin content in light | 38.0% | 38.0% | 36.7% | 38.0% | 38.0% |
| curable aqueous emulsion | | | | | |
| TPO content in light | 2.0% | 2.0% | 3.3% | 2.0% | 2.0% |
| curable aqueous emulsion | | | | | |

TABLE 4

| | | Example | Example | Example | Example | Example | Example |
|---|---|---|---|---|---|---|---|
| | | 8 | 9 | 10 | 11 | 12 | 13 |
| Self-dispersed pigment | | 20 | — | — | — | — | — |
| dispersion | | | | | | | |
| (Cab-o-jet-260M) | | | | | | | |
| Self-dispersed pigment | | — | 8.3 | 8.3 | 8.3 | 8.3 | 8.3 |
| dispersion | | | | | | | |
| (Cab-o-jet-300) | | | | | | | |
| 2-Pyrrolidone | | 5 | — | — | — | — | — |
| Triethylene glycol | | 3 | — | — | — | — | — |
| TEGmBE | | 0.8 | — | — | — | — | — |
| Propylene glycol | | — | 8 | 8 | 8 | 8 | 8 |
| 1,2-Hexanediol | | — | 3 | 3 | 3 | 3 | 3 |
| BYK348 | | 0.3 | 1 | 1 | 1 | 1 | 1 |
| BYK333 | | — | 0.3 | 0.3 | 0.3 | 0.3 | 0.3 |
| Light | d-2 | 70 | 27.2 | — | — | — | — |
| curable | d-5 | — | — | 27.5 | — | — | — |
| aqueous | e-1 | — | — | — | 30 | — | — |
| emulsions | d-6 | — | — | — | — | 27.3 | — |
| | d-7 | — | — | — | — | — | 27.4 |
| | e-2 | — | — | — | — | — | — |
| | e-3 | — | — | — | — | — | — |
| | e-4 | — | — | — | — | — | — |
| | e-5 | — | — | — | — | — | — |
| | e-6 | — | — | — | — | — | — |
| Water | Ion exchanged | 0.9 | 52.2 | 51.9 | 49.4 | 52.1 | 52 |
| | water | | | | | | |

| | | | | | | |
|---|---|---|---|---|---|---|
| Total amount | 100 | 100 | 100 | 100 | 100 | 100 |
| Resin content in light | 36.7 | 36.7 | 36.5 | 33.3 | 36.6 | 36.5 |
| curable aqueous emulsion | | | | | | |
| TPO content in light | 3.3 | 3.3 | 3.3 | 5 | 3.3 | 3.3 |
| curable aqueous emulsion | | | | | | |
| DETX content in light | — | — | — | 1.7 | — | — |
| curable aqueous emulsion | | | | | | |
| KCB content in light | — | — | 0.13 | 0.07 | — | 0.07 |
| curable aqueous emulsion | | | | | | |
| Content of urethane | — | — | — | 1.7 | — | — |
| acrylate for fixing in | | | | | | |
| light curable aqueous | | | | | | |
| emulsion | | | | | | |

| | | Example | Example | Example | Example | Example |
|---|---|---|---|---|---|---|
| | | 14 | 15 | 16 | 17 | 18 |
| Self-dispersed pigment | | — | — | — | — | — |
| dispersion | | | | | | |
| (Cab-o-jet-260M) | | | | | | |
| Self-dispersed pigment | | 8.3 | 8.3 | 8.3 | 8.3 | 8.3 |
| dispersion | | | | | | |
| (Cab-o-jet-300) | | | | | | |
| 2-Pyrrolidone | | — | — | — | — | — |
| Triethylene glycol | | — | — | — | — | — |
| TEGmBE | | — | — | — | — | — |
| Propylene glycol | | 8 | 8 | 8 | 8 | 8 |
| 1,2-Hexanediol | | 3 | 3 | 3 | 3 | 3 |
| BYK348 | | 1 | 1 | 1 | 1 | 1 |
| BYK333 | | 0.3 | 0.3 | 0.3 | 0.3 | 0.3 |
| Light | d-2 | — | — | — | — | — |
| curable | d-5 | — | — | — | — | — |
| aqueous | e-1 | — | — | — | — | — |
| emulsions | d-6 | — | — | — | — | — |
| | d-7 | — | — | — | — | — |
| | e-2 | 27.3 | — | — | — | — |
| | e-3 | — | 30 | — | — | — |
| | e-4 | — | — | 30 | — | — |
| | e-5 | — | — | — | 30 | — |
| | e-6 | — | — | — | — | 30 |
| Water | Ion exchanged | 52.1 | 49.4 | 49.4 | 49.4 | 49.4 |
| | water | | | | | |

| | | | | | |
|---|---|---|---|---|---|
| Total amount | 100 | 100 | 100 | 100 | 100 |
| Resin content in light | 36.6 | 33.3 | 33.3 | 33.3 | 33.3 |
| curable aqueous emulsion | | | | | |
| TPO content in light | 3.3 | 6.7 | 5 | 5 | 5 |
| curable aqueous emulsion | | | | | |
| DETX content in light | — | — | 1.7 | 1.7 | 1.7 |
| curable aqueous emulsion | | | | | |
| KCB content in light | 0.07 | 0.06 | 0.06 | — | 0.06 |
| curable aqueous emulsion | | | | | |
| Content of urethane | — | — | — | 1.5 | 1.5 |
| acrylate for fixing in | | | | | |
| light curable aqueous | | | | | |
| emulsion | | | | | |

Measurement Items and Evaluation Items

Viscosity of Ink

The viscosity of ink was measured with the digital viscometer VM-100 manufactured by Yamaichi Electronics Co., Ltd. The measurement results are shown in Table 5 presented below. In Table 5, the unit is “mPa·s,” and the symbol “-” means that the measurement was impossible.

Surface Tension of Ink

The surface tension of ink was measured with the CBVP-Z manufactured by Kyowa Interface Science Co., Ltd. The measurement results are shown in Table 5 presented below. In Table 5, the unit is “mN/m,” and the symbol “-” means that the measurement was impossible.

Ejection Stability of Ink

Ink was filled in a black ink cartridge of the ink jet printer EM-930C (trade name of a product of Seiko-Epson Corp.), character patterns were printed continuously on 100 sheets of A4 paper, and the occurrence or nonoccurrence of the dot loss and ink scattering on these sheets were observed.

The evaluation standards are as follows. The evaluation results are shown in Tables 5 and 6 presented below. In Tables 5 and 6, the symbol “-” means that the measurement was impossible (ejection was impossible).

A: The number of occurrences of dot loss and ink scattering was 30 or less, and the dot loss and ink scattering were recovered by cleaning.

B: The number of occurrences of dot loss and ink scattering was 31 to 49, and the dot loss and ink scattering were recovered by cleaning.

C: The number of occurrences of dot loss and ink scattering was 50 or more, and the dot loss and ink scattering were not recovered by cleaning.

Storage Stability of Ink

Ink was allowed to stand still at 40° C., and the condition variation of the ink was observed. The observation results were classified according to the following evaluation standards. The results are shown in Tables 5 and 6 presented below.

A: Even when the ink was allowed to stand for one week or more, no occurrence of phase separation and precipitation was found without variation from the initial condition.

B: When the ink was allowed to stand for one week, the occurrence of phase separation or precipitation was found.

C: Immediately after the preparation of the ink, the occurrence of phase separation or precipitation was found.

Curability of Ink in Each of Examples 1 to 7 and Comparative Examples

Tackiness evaluation was performed rubbing with a cotton swab. Specifically, first, each of the ink compositions prepared above in Examples 1 to 7 and Comparative Examples was applied onto a PET film with a bar coater No. 6, and after an elapsed time of 120 seconds, the coating film was irradiated with ultraviolet light. As the ultraviolet light irradiation lamp, an LED lamp was used. Then, the surface of the coating film was rubbed with a cotton swab, and the irradiation energy resulting in no coloration of the cotton swab was evaluated as the curing energy. The lower curing energy indicates that the ink composition is the more excellent in curability.

The evaluation results are shown in Table 5 presented below. In Table 5, the unit is “mJ/cm²,” and the symbol “-” means that the evaluation was impossible because the ink had undergone phase separation.

Curability of Ink in Each of Examples 8 to 18

Tackiness evaluation was performed by rubbing with a cotton swab. Specifically, first, each of the ink compositions prepared above of Examples 8 to 18 was applied onto a PVC film with a bar coater No. 6, and after a drying of at 50° C. for 3 minutes, the coating film was irradiated with ultraviolet light. As the ultraviolet light irradiation lamp, an LED lamp was used. Then, the surface of the coating film was rubbed with a cotton swab, and the irradiation energy resulting in no coloration of the cotton swab was evaluated as the curing energy. The lower curing energy indicates that the ink composition is the more excellent in curability. The evaluation standards are as follows.

AA: The curing energy of the ink was 300 mJ/cm² or less on the PVC film.

A: The curing energy of the ink was larger than 300 mJ/cm² and 1,000 mJ/cm² or less on the PVC film.

B: The curing energy of the ink was larger than 1,000 mJ/cm² and 1,500 mJ/cm² or less on the PVC film.

C: The curing energy of the ink was larger than 1,500 mJ/cm² on the PVC film.

The evaluation results are shown in Table 6 presented below. The ink composition of Example 8 was set to be the same as in Example 5. Thus, the evaluation results of Examples 1 to 7 and comparative Examples were made to be able to be compared with the evaluation results of Examples 8 to 18.

Adhesiveness of Ink

Adhesive evaluation was performed on the basis of tape peeling test. Specifically, each of the prepared inks was applied onto a PET film and a PVC film with a bar coater so as for the application thickness to be 20 μm, the applied ink was dried at 50° C. for 3 minutes, and then irradiated with ultraviolet light. For the irradiation, an LED was used.

Then, the tape peeling test was performed. The evaluation standards are as follows. The evaluation results are in Table 6 presented below.

A: The ink was not tape-peeled from both of the PET and PVC films.

B: The ink was not tape-peeled from the PET film, but the ink was tape-peeled from the PVC film.

C: The ink was tape-peeled from both of the PET and PVC films.

TABLE 5

| | a-1 | b-1 | c-1 | d-1 | d-2 | d-3 | d-4 |
|---|---|---|---|---|---|---|---|
| | Example | Example | Example | Example | Example | Example | Example |
| | 1 | 2 | 3 | 4 | 5 | 6 | 7 |
| Viscosity | 10 | 21 | 11 | 21 | 17 | 20 | 17 |
| Surface tension | 29 | 29 | 29 | 29 | 29 | 29 | 29 |
| Ejection stability | A | A | A | A | A | A | A |
| Storage stability | A | A | A | A | A | A | A |
| Curing energy | 300 | 300 | 200 | 80 | 30 | 50 | 30 |

| | p-1 | q-1 | q-2 | s-1 | t-1 |
|---|---|---|---|---|---|
| | Comparative | Comparative | Comparative | Comparative | Comparative |
| | Example | Example | Example | Example | Example |
| | 1 | 2 | 3 | 4 | 5 |
| Viscosity | — | 37 | 25 | 43 | — |
| Surface tension | — | 29 | 29 | 29 | — |
| Ejection stability | — | C | B | C | — |
| Storage stability | C | A | B | B | C |
| Curing energy | — | 300 | 150 | — | — |

TABLE 6

| | d-2 | d-2 | d-5 | e-1 | d-6 | d-7 | e-2 | e-3 | e-4 | e-5 | e-6 |
|---|---|---|---|---|---|---|---|---|---|---|---|
| | Example | Example | Example | Example | Example | Example | Example | Example | Example | Example | Example |
| | 8 | 9 | 10 | 11 | 12 | 13 | 14 | 15 | 16 | 17 | 18 |
| Ejection | A | A | A | A | A | A | A | A | A | A | A |
| stability | | | | | | | | | | | |
| Storage | A | A | A | A | A | A | A | A | A | A | A |
| stability | | | | | | | | | | | |
| Curability | AA | C | A | AA | B | A | A | AA | AA | AA | AA |
| Adhesiveness | B | B | B | A | B | B | B | B | B | A | A |

The symbols presented in the uppermost rows of Tables 5 and 6 represent the light curable aqueous emulsions shown in Tables 1 and 2 presented above. As shown in Table 5, as compared to the ink compositions of Comparative Examples 1 to 5, the ink compositions of Examples 1 to 7 are the same in surface tension, but are found to be lower in ink viscosity, and more excellent in any of the ejection stability of ink, the storage stability of ink and the curability of ink.

Also, as shown in Table 6, as compared to the ink compositions of Comparative Examples 1 to 5, the ink compositions of Examples 8 to 18 were found be more excellent in any of the ejection stability of ink, the storage stability of ink and the curability of ink. As the pigments in Examples 9 to 18, Cab-o-jet-300 (self-dispersed black pigment dispersion) was used in place of Cab-o-jet-260M (self-dispersed magenta pigment dispersion); this was for the purpose of verifying that the ink compositions of the present invention are excellent in curability even when combined with a hardly curable black ink.

As Reference Examples 1 to 18, ink compositions containing no pigment in which the pigment dispersions in Example 1 to 18 were replaced with water and no pigment was contained were prepared. The average particle sizes of the ink compositions of Reference Examples 1 to 18 were measured with the Microtrac UPA 150 and all were found to fall within a range from 50 to 800 nm.

What is claimed is:

1. An ink composition for ink jet comprising: a pigment; a water-soluble organic solvent; a surfactant; at least either of a urethane (meth)acrylate being represented by the following general formula (1) and having a weight average molecular weight of 1,000 to 10,000 and a cross-linked urethane (meth)acrylate having a constitutional unit including the urethane (meth)acrylate; a compound having a radical polymerizable group(s); a photoradical polymerization initiator; and water:
A¹-O—(CONH—B¹—NHCOO—C¹—O)ₙ—CONH—B¹—NH—COO-D¹ (1)
wherein in formula (1), n represents a natural number of 1 to 30, A¹ represents a residue of a hydroxyl group-containing (meth)acrylate, B¹ represents a residue of diisocyanate, C¹ represents a residue of a diol of an acyclic hydrocarbon or a cyclic hydrocarbon, and D¹ represents a residue of a polyoxyalkylene glycol monoalkyl ether.

2. The ink composition for ink jet according to claim 1, wherein the urethane (meth)acrylate is obtained by allowing to react with each other the hydroxyl group-containing (meth)acrylate, the diisocyanate, the diol of the acyclic hydrocarbon or the cyclic hydrocarbon and the polyoxyalkylene glycol monoalkyl ether.

3. The ink composition for ink jet according to claim 1, wherein the diisocyanate is one or more selected from the group consisting of isophorone diisocyanate, hexamethylene diisocyanate, hydrogenated xylylene diisocyanate and hydrogenated diphenylmethane diisocyanate.

4. The ink composition for ink jet according to claim 1, wherein the number of carbon atoms in the diol of the acyclic hydrocarbon or the cyclic hydrocarbon is 6 to 20.

5. The ink composition for ink jet according to claim 4, wherein the diol, having a number of carbon atoms of 6 to 20, of the acyclic hydrocarbon or the cyclic hydrocarbon is one or more selected from the group consisting of 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanediol, 1,20-eicosanediol, polypropylene glycol, aliphatic polycarbonate polyol, aliphatic polyester polyol, aliphatic polycaprolactone diol, hydrogenated bisphenol A, ethylene oxide-modified hydrogenated bisphenol A, propylene oxide-modified hydrogenated bisphenol A, 1,4-cyclohexanediol and tricyclodecanedimethanol.

6. The ink composition for ink jet according to claim 1, wherein the hydroxyl group-containing (meth)acrylate is one or more selected from the group consisting of polypropylene glycol mono(meth)acrylate, pentaerythritol tri(meth)acrylate and di pentaerythritol penta(meth)acrylate.

7. The ink composition for ink jet according to claim 1, wherein the polyoxyalkylene glycol monoalkyl ether is represented by the following general formula (2):
HO—(CH₂CH₂O)ₘ—R (2)
wherein in formula (2), R represents an alkyl group and m represents a natural number of 9 to 90.

8. The ink composition for ink jet according to claim 1, wherein the cross-linked urethane (meth)acrylate is prepared by cross-linking with a bifunctional or higher functional cross-linking agent.

9. The ink composition for ink jet according to claim 8, wherein the cross-linking agent is a mercapto group-containing compound.

10. The ink composition for ink jet according to claim 1, wherein a light curable aqueous emulsion comprises:
at least either of the urethane (meth)acrylate and the cross-linked urethane (meth)acrylate; and
the compound having a radical polymerizable group(s) and the photoradical polymerization initiator emulsified and dispersed with at least either of the urethane (meth)acrylate and the cross-linked urethane (meth)acrylate.

11. The ink composition for ink jet according to claim 10, wherein the compound having a radical polymerizable group(s) is a compound having in the molecule thereof three or more (meth)acryloyl groups.

12. The ink composition for ink jet according to claim 1, wherein the photoradical polymerization initiator is a hydrophobic photopolymerization initiator.

13. The ink composition for ink jet according to claim 1, wherein the photoradical polymerization initiator comprises two or more photoradical polymerization initiators including at least a thioxanthone-based photoradical polymerization initiator.

14. The ink composition for ink jet according to claim 1, wherein the compound having a radical polymerizable group(s) comprises a urethane (meth)acrylate for fixing.

15. The ink composition for ink jet according to claim 1, further comprising a fluorescent brightening agent.

16. The ink composition for ink jet according to claim 1, wherein the water-soluble organic solvent comprises at least either of a polar solvent and a permeable solvent.

17. The ink composition for ink jet according to claim 16, wherein the polar solvent is a heterocyclic compound.
